(19) United States
(12) Patent Application Publication
(10) Pub. No.: US 2025/0117897 A1
(43) Pub. Date: Apr. 10, 2025

(54) SYSTEM AND METHOD FOR PARALLEL DENOISING DIFFUSION

(71) Applicant: IKIN, Inc., Dripping Springs, TX (US)

(72) Inventors: Bryan Lloyd WESTCOTT, Austin, TX (US); Christopher Henry VELA, Dripping Springs, TX (US)

(21) Appl. No.: 18/907,166

(22) Filed: Oct. 4, 2024

Related U.S. Application Data
(60) Provisional application No. 63/589,248, filed on Oct. 10, 2023.

(51) Int. Cl. G06T 5/70; G06T 5/10; G06V 10/28

(52) U.S. Cl. CPC G06T 5/70; G06T 5/10; G06V 10/28; G06T 2207/20182

(57) ABSTRACT

A pioneering parallel diffusion technique individually represents and diffuses each bit or groups of bits. The approach addresses inefficiencies observed in traditional diffusion processes. The approach may reduce the number of iterations required for denoising, thereby decreasing denoising latency and improving overall processing speed. These advantages are especially crucial in the realm of codec applications where real-time processing and resource efficiency are paramount.

### CROSS-REFERENCE TO RELATED APPLICATIONS

This application claims priority to U.S. Provisional Patent Application 63/589,248, filed Oct. 10, 2023, the contents of which are incorporated herein by reference.

### FIELD

The present disclosure generally relates to techniques for image generation and processing and, more particularly, to methods for image generation using trained diffusion models.

### BACKGROUND

In recent years, there has been a surge in the application of trained diffusion models for image generation and enhancement. Trained diffusion models, such as the Stable Diffusion model, represent a departure from traditional denoising approaches by leveraging machine learning techniques to iteratively refine image data. These models often employ sophisticated algorithms that learn intricate patterns and relationships within image datasets, providing powerful tools for generating high-quality visual content.

However, generating images using diffusion models can be relatively time consuming, limiting their utility in time-sensitive applications.

### SUMMARY

Despite the advancements achieved by trained diffusion models, the analysis of diffusion changes during denoising iterations has revealed certain inefficiencies, particularly in the context of numerical value alterations. Traditional diffusion processes, even when guided by trained models, exhibit non-uniform changes across numerical values, specifically within the realm of bit values representing image pixels. This non-uniformity translates into sparse alterations, with only select bits undergoing changes during each iteration. In light of the observed inefficiencies in conventional diffusion processes, including those guided by trained models, a unique opportunity for optimization has been identified.

Disclosed herein is a pioneering parallel diffusion technique. By individually representing and diffusing each bit or groups of bits, the approach addresses inefficiencies observed in traditional diffusion processes. The disclosed approach may reduce the number of iterations required for denoising, thereby decreasing denoising latency and improving overall processing speed. These advantages are especially crucial in the realm of codec applications where real-time processing and resource efficiency are paramount.

In one aspect the disclosure relates to a computer-implemented method for parallel diffusion. The method includes receiving one or more training images where each of the training images includes a plurality of pixels and each of the plurality of pixels is represented by multiple bits. The multiple bits representing each of the plurality of pixels of each of the training images are transformed into a set of floating-point values. The method further includes training, using the set of floating-point values for each of the plurality of pixels of each of the training images, a machine-implemented diffusion model to generate reconstructed images corresponding to the training images. The machine-implemented diffusion model includes a noising model configured to introduce noise into each set of floating-point values in order to produce intermediate data and a denoising model configured to generate reconstructed image data from the intermediate data.

The transforming may further include, for each pixel of the plurality of pixels of each of the training images, applying multiple bit masks arranged in parallel to the multiple bits of the pixel wherein different ones of the bit masks are configured to mask different ones of the multiple bits of the pixel to and convert integer outputs resulting from the applying of the multiple bit masks into the set of floating-point values for the pixel.

The disclosure also pertains to a computing system configured to implement a parallel diffusion process. The computing system includes one or more processors and one or more non-transitory, computer-readable media storing a machine-implemented diffusion model including a noising model and a denoising model. The computer-readable media further store instructions that, when executed by the one or more processors, cause the one or more processors to (i) receive one or more training images where each of the training images includes a plurality of pixels and each of the plurality of pixels is represented by multiple bits and (ii) transform the multiple bits representing each of the plurality of pixels of each of the training images into a set of floating-point values. The instructions further cause the one or more processors to train, using the set of floating-point values for each of the plurality of pixels of each of the training images, the machine-implemented diffusion model to generate reconstructed images corresponding to the training images. The noising model is configured to introduce noise into each set of floating-point values in order to produce intermediate data and the denoising model is configured to generate reconstructed image data from the intermediate data.

The instructions to transform may further include instructions which, for each pixel of the plurality of pixels of each of the training images, cause the one or more processors to (i) apply multiple bit masks arranged in parallel to the multiple bits of the pixel wherein different ones of the bits masks are configured to mask different ones of the multiple bits of the pixel to yield integer outputs and to (ii) convert the integer outputs into the set of floating-point values for the pixel.

In another aspect the disclosure relates to a computer-implemented method for parallel diffusion which includes receiving an input image including a plurality of pixels where each of the plurality of pixels is represented by multiple bits. The multiple bits representing each of the plurality of pixels of the input image are transformed into a set of floating-point values. The set of floating-point values for each of the plurality of pixels of the input image are provided to a denoising model of a machine-trained diffusion model and the denoising model then generates successive sets of floating-point values. The method further includes reconstructing the plurality of pixels of the input image from the successive sets of floating-point values.

The transforming may further includes, for each pixel of the plurality of pixels of the input image (i) applying multiple bit masks arranged in parallel to the multiple bits of the pixel wherein different ones of the bits masks are applied to different ones of the multiple bits of the pixel and (ii) converting integer outputs resulting from the applying of the multiple bit masks into the set of floating-point values for the pixel.

The disclosure is further directed to a computing system for parallel diffusion which includes one or more processors and one or more non-transitory, computer-readable media. The computer-readable media store a machine-implemented diffusion model including a denoising model and instructions that, when executed by the one or more processors, cause the one or more processors to receive an input image including a plurality of pixels where each of the plurality of pixels is represented by multiple bits. The instructions further cause the one or more processors to transform the multiple bits representing each of the plurality of pixels of the input image into a set of floating-point values and to provide the set of floating-point values for each of the plurality of pixels of the input image to the denoising model. The denoising model generates successive sets of floating-point values. The instructions further cause the one or more processors to reconstruct the plurality of pixels of the input image from the successive sets of floating-point values.

The instructions to transform further include instructions which, for each pixel of the plurality of pixels of the input image, cause the one or more processors to (i) apply multiple bit masks arranged in parallel to the multiple bits of the pixel wherein different ones of the bits masks are applied to different ones of the multiple bits of the pixel to yield integer outputs and to (ii) convert the integer outputs into the set of floating-point values for the pixel.

Embodiments of the present disclosure may further relate to a computer-implemented method, including receiving one or more training images where each of the training images includes a plurality of pixels and each of the plurality of pixels may be represented by multiple bits. Embodiments may also include factoring the multiple bits representing each of the plurality of pixels of each of the training images into a set of bit multiples. Each set of bit multiples may be encoded into a set of floating-point values. Embodiments may also include training, using the set of floating-point values for each of the plurality of pixels of each of the training images, a machine-implemented diffusion model to generate reconstructed images corresponding to the training images. In some embodiments, the machine-implemented diffusion model includes a noising model configured to introduce noise into each set of floating-point values to produce intermediate data and a denoising model configured to generate reconstructed image data from the intermediate data.

In some embodiments, the factoring includes, for each pixel of the plurality of pixels of each of the training images, generating a set of quotients by performing a set of division operations using a corresponding set of constants. In some embodiments, a first of the division operations includes dividing the multiple bits of the pixel by a first constant, thereby generating a first quotient of the set of quotients and a first remainder. In some embodiments, a second of the division operations includes dividing the first remainder by a second constant, thereby generating a second quotient of the set of quotients and a second remainder.

In some embodiments, the computer-implemented method may include converting the set of quotients into the set of floating-point values for the pixel. In some embodiments, the training further includes decoding successive sets of floating-point values generated by the denoising model into successive sets of binary values. In some embodiments, each of the successive sets of floating-point values corresponds to one of the plurality of pixels of one of the training images. The training may further include, for each successive set of binary values multiplying each binary value of each successive set of binary values by a different constant of the set of constants. Embodiments may also include adding results of the multiplying to generate multiple reconstructed bits of one pixel of the plurality of pixels of one of the training images.

In some embodiments, the instructions to factor further include instructions which, for each pixel of the plurality of pixels of each of the training images, cause the one or more processors to generate a set of quotients by performing a set of division operations using a corresponding set of constants. In some embodiments, a first of the division operations includes dividing the multiple bits of the pixel by a first constant, thereby generating a first quotient of the set of quotients and a first remainder. In some embodiments, a second of the division operations includes dividing the first remainder by a second constant, thereby generating a second quotient of the set of quotients and a second remainder.

In some embodiments, the instructions to train further include instructions to decode successive sets of floating-point values generated by the denoising model into successive sets of binary values. In some embodiments, each of the successive sets of floating-point values corresponds to one of the plurality of pixels of one of the training images.

In some embodiments, the instruction to train further include instructions, for each successive set of binary values, to cause the one or more processors to multiply each binary value of each successive set of binary values by a different constant of the set of constants to yield successive sets of multiplied binary values. Embodiments may also include adding the multiplied binary values within each successive set of multiplied binary values to generate multiple reconstructed bits of one pixel of the plurality of pixels of one of the training images.

Embodiments of the present disclosure may also include a computing system, including one or more processors and one or more non-transitory, computer-readable media storing a machine-implemented diffusion model including a denoising model. The computer-readable media may also store instructions that, when executed by the one or more processors, cause the one or more processors to receive an input image including a plurality of pixels. Each of the plurality of pixels may be represented by multiple bits. Embodiments may also include factoring the multiple bits representing each of the plurality of pixels of the input image into a set of bit multiples. Embodiments may also include encoding each set of bit multiples into a set of floating-point values.

Embodiments may also include training, using the set of floating-point values for each of the plurality of pixels of each of the training images, a machine-implemented diffusion model to generate reconstructed images corresponding to the training images. In some embodiments, the machine-implemented diffusion model includes a noising model configured to introduce noise into each set of floating-point values to produce intermediate data and a denoising model configured to generate reconstructed image data from the intermediate data.

The disclosure also relates to a computer-implemented method for parallel diffusion which includes receiving an input image including a plurality of pixels where each of the plurality of pixels is represented by multiple bits. The method includes factoring the multiple bits representing each of the plurality of pixels of the input image into a set of bit multiples. Each set of bit multiples are encoded into a set of floating-point values and the set of floating-point values for each of the plurality of pixels of the input image is provided to a denoising model of a machine-trained diffusion model. The denoising model then generates successive sets of floating-point values. The method further includes reconstructing the plurality of pixels of the input image from the successive sets of floating-point values.

The factoring may further include, for each pixel of the plurality of pixels of the input image, generating a set of quotients by performing a set of division operations using a corresponding set of constants. A first of the division operations may include dividing the multiple bits of the pixel by a first constant, thereby generating a first quotient of the set of quotients and a first remainder. A second of the division operations may include dividing the first remainder by a second constant, thereby generating a second quotient of the set of quotients and a second remainder.

In yet another aspect the disclosure is directed to a computing system configured to perform parallel diffusion. The computing system includes one or more processors and one or more non-transitory, computer-readable media storing a machine-implemented diffusion model including a denoising model. The computer-readable media further includes instructions that, when executed by the one or more processors, cause the one or more processors to receive an input image including a plurality of pixels where each of the plurality of pixels is represented by multiple bits. The one or more processors may be further caused by the instructions to factor the multiple bits representing each of the plurality of pixels of the input image into a set of bit multiples and to encode each set of bit multiples into a set of floating-point values. The set of floating-point values for each of the plurality of pixels of the input image are provided to a denoising model of a machine-trained diffusion model operative to generate successive sets of floating-point values. The instructions further cause the one or more processors to reconstruct the plurality of pixels of the input image from the successive sets of floating-point values.

The instructions to factor may further include instructions which, for each pixel of the plurality of pixels of each of the input image, cause the one or more processors to generate a set of quotients by performing a set of division operations using a corresponding set of constants. A first of the division operations may include dividing the multiple bits of the pixel by a first constant, thereby generating a first quotient of the set of quotients and a first remainder. A second of the division operations may include dividing the first remainder by a second constant, thereby generating a second quotient of the set of quotients and a second remainder.

The disclosure is further directed to a computer-implemented method for parallel diffusion. The method includes receiving one or more training images where each of the training images includes a plurality of pixels and each of the plurality of pixels is represented by multiple bits. The multiple bits representing each pixel of the plurality of pixels of each of the training images are transformed into a set of floating-point values wherein at least two adjacent bits of the multiple bits representing the pixel are represented by each floating-point value of the set of floating-point values for the pixel. The method also includes training, using the set of floating-point values for each of the plurality of pixels of each of the training images, a machine-implemented diffusion model to generate reconstructed images corresponding to the training images wherein the machine-implemented diffusion model includes a noising model configured to introduce noise into each set of floating-point values in order to produce intermediate data and a denoising model configured to generate reconstructed image data from the intermediate data.

The transforming operation may further include, for each pixel of the plurality of pixels of each of the training images, applying multiple bit masks arranged in parallel to the multiple bits of the pixel wherein different ones of the bit masks are configured to mask a plurality of different ones of the multiple bits of the pixel. The transforming operation may additionally include bit shifting integer outputs resulting from the applying of the multiple bit masks and encoding bit-shifted integer outputs resulting from the bit shifting into the set of floating-point values for the pixel.

In another aspect the disclosure pertains to a computer-implemented method for parallel diffusion. The method includes receiving an input image including a plurality of pixels where each of the plurality of pixels is represented by multiple bits. The multiple bits representing each pixel of the plurality of pixels of the input image are transformed into a set of floating-point values wherein at least two adjacent bits of the multiple bits representing the pixel are represented by each floating-point value of the set of floating-point values for the pixel. The set of floating-point values for each of the plurality of pixels of the input image are provided to a denoising model of a machine-trained diffusion model configured to generate successive sets of floating-point values wherein at least two adjacent bits of the multiple bits representing each pixel of the plurality of pixels of the input image are represented by each floating-point value of the set of floating-point values for the pixel. The method further includes reconstructing the plurality of pixels of the input image from the successive sets of floating-point values.

The transforming may further include, for each pixel of the plurality of pixels of the input image, applying multiple bit masks arranged in parallel to the multiple bits of the pixel wherein different ones of the bit masks are configured to mask a plurality of different ones of the multiple bits of the pixel. The transforming may additionally include bit shifting integer outputs resulting from the applying of the multiple bit masks and encoding bit-shifted integer outputs resulting from the bit shifting to yield the set of floating-point values for the pixel.

### BRIEF DESCRIPTION OF THE DRAWINGS

The invention is more fully appreciated in connection with the following detailed description taken in conjunction with the accompanying drawings, in which:

FIG. 1 illustrates a diffusion-based novel view synthesis (DNVS) communication system in accordance with an embodiment.

FIG. 2 illustrates a process for conditionally training a diffusion model for use in diffusion-based communication in accordance with an embodiment.

FIG. 3 illustrates another diffusion-based novel view synthesis (DNVS) communication system in accordance with an embodiment.

FIG. 4 illustrates an alternative diffusion-based novel view synthesis (DNVS) communication system in accordance with an embodiment.

FIG. 5 illustrates another diffusion-based novel view synthesis (DNVS) communication system in accordance with an embodiment.

FIG. 6 illustrates a diffusion-based video streaming and compression system in accordance with an embodiment.

FIG. 7 illustrates a diffusion-based video streaming and compression system in accordance with another embodiment.

FIG. 8 is a block diagram representation of an electronic device configured to operate as a DNVS sending and/or DNVS receiving device.

FIG. 9A illustrates specialized adaptation of weights via a new keyframe.

FIG. 9B illustrates specialized adaptation of weights via a cache.

FIG. 10 illustrates an exemplary adapted diffusion codec process in accordance with an embodiment.

FIG. 11 illustrates an exemplary process flow for the use of video diffusion complementary to conventional video compression in accordance with an embodiment.

FIG. 12A shows an image created by the diffusion model after N−2 iterations.

FIG. 12B shows an image created by the diffusion model after N−1 iterations.

FIG. 12C shows an image created by the diffusion model after N iterations.

FIG. 13 is a graph of change density by pixel numerical value as a function of the number of iterations of the diffusion process yielding the images of FIGS. 12-12C.

FIG. 14 is a graph illustrating bit change density as a function of the number of diffusion iterations, normalized per bit.

FIG. 15 illustrates an exemplary parallel diffusion process for image generation in accordance with an embodiment.

FIG. 16 illustrates another exemplary parallel diffusion process for image generation in accordance with an embodiment.

FIG. 17 illustrates another variation of an exemplary parallel diffusion process for image generation in accordance with an embodiment.

FIG. 18 illustrates a process for conditionally training a diffusion model for use in parallel diffusion in accordance with an embodiment.

Like reference numerals refer to corresponding parts throughout the several views of the drawings.

### DETAILED DESCRIPTION

### Introduction

### Conditional Diffusion for Video Communication and Streaming

In one aspect the disclosure relates to a conditional diffusion process capable of being applied in video communication and streaming of pre-existing media content. As an initial matter consider that the process of conditional diffusion may be characterized by Bayes' theorem:

p(x|y)=p(y|x)*p(x)/p(y)

One of the many challenges of practical use of Bayes' theorem is that it is intractable to compute p(y). One key to utilizing diffusion is to use score matching (log of the likelihood) to make p(y) go away in the loss function (the criteria used by the machine-learning (ML) model training algorithm to determine what a “good” model is). This yields:

E_p(x)log[p(x|y)]=E_p(x)log[p(y|x)p(x)/p(y)]

=E_p(x)[log(p(y|x))+log(p(x)−log(p(y))]

=E_p(x)[log(p(y|x))+log(p(x)]

Since p (x) remains unknown an unconditional diffusion model is used, along with a conditional diffusion model for p(y|x). One principal benefit of this approach is that it is learned how to invert a process (p(y|x)) but balance that progress with the prior (p(x)), which enables learning from experience and provides improved realism (or improved adherence to a desired style). The use of the high-quality diffusion models will allow low-bandwidth, sparse representations (y) to be improved.

To use this approach in video communication or a 3D-aware/holographic chat session, the relevant variables in this context may be characterized as follows:
x is image(s) of a specific face in a lot of different expressions and a lot of different poses gives you the unconditional diffusion model q(x) that approximates p(x)
y is the 3D face mesh coordinates (e.g., MediaPipe, optionally to include body pose coordinates and even eye gaze coordinates), in the most basic form but may also include additional dimensions (e.g., RGB values at those coordinates).
We simply use MediaPipe to produce y from x and thus we can train the conditional diffusion model q(y|x) that estimates p(y|x) using diffusion.
Then we have everything we need to optimize the estimate of p(x|y).

How would this approach work in a holographic chat or 3D aware communication context? In the case of holographic chat, one key insight is that the facial expressions and head/body pose relative to the captured images can vary. This means that a receiver with access to q(y|x) can query a new pose by moving those rigid 3D coordinates (y) around in 3D space to simulate parallax. This has two primary benefits:
1. they are sparse and thus require less bandwidth
2. They can be rotated purely at the receiver thus providing parallax for holographic video

A holographic chat system would begin by training a diffusion model (either from scratch or as a customization as is done with LoRA) on a corpus of selected images (x), and face mesh coordinates (y) derived from the images, for the end user desiring to transmit their likeness. Those images may be in a particular style: e.g., in business attire, with combed hair, make-up, etc. After that model q(y|x) is transmitted, you can then then transmit per-frame face mesh coordinates, and then we simply use our head-tracking to query the view we need to provide parallax. The key is an unconditional noise process model q(y|x) is sent from a transmitter to a receiver once. After the unconditional noise process has been sent, the transmitter just sends per-frame face mesh coordinates (y).

Set forth below are various possible some extensions made possible by this approach:
Additional dimensions of information could be provided with each face mesh point, for example RGB values, which gives some additional information on the extrinsic illumination.
Body pose coordinates could be added and altered independently of the face/eyes, allowing the gaze direction of the user to be synthetically altered. When combined with knowledge of the viewer's location and monitor information, this could provide virtual eye contact that is not possible with current webchat as a camera would need to be positioned in the middle of the monitor.
Any other additional low bandwidth/sparse information (discussed in compression section) could be added, including background information. The relative poses of the user and the background could be assisted with embedded or invisible (to the human eye) fiducial markers such as ArUco markers.
If we track the gaze of the receiving user, we could selectively render/upsample the output based on the location being at any given moment, which saves rendering computation.
   For more general and non-3D-aware applications (e.g., for monocular video) the transmitter could use several sparse representations for transmitted data (y) including:
canny edge locations, optionally augmented with RGB and/or depth (from a library such as DPT)
features used for computer vision (e.g., DINO, SIFT)
a low-bandwidth (low-pass-filtered) and downsampled version of the input.
AI feature correspondences: transmit the feature correspondence locations and ensure the conditional diffusion reconstructs those points to correspond correctly in adjacent video frames.
   Note: this is different from the TokenFlow video diffusion approach as it enforces the correspondences on the generative/stylized output.

This process may be utilized in a codec configured to, for example, compress a and transmit new or existing video content. In this case the transmitter would train q(x) on a whole video, a whole series of episodes, a particular director, or an entire catalog. Note that such training need not be on the entirety of the diffusion model but could involve training only select layers using, for example, a low-rank adapter such as LoRA. This model (or just the low-rand adapter) would be transmitted to the receiver. Subsequently, the low-rank/low-bandwidth information would be transmitted, and the conditional diffusion process would reconstruct the original image. In this case the diffusion model would learn the decoder, but the prior (q(x)) keeps it grounded and should reduce the uncanny valley effect.

### Exemplary Embodiments for Diffusion-Based Video Communications and Streaming

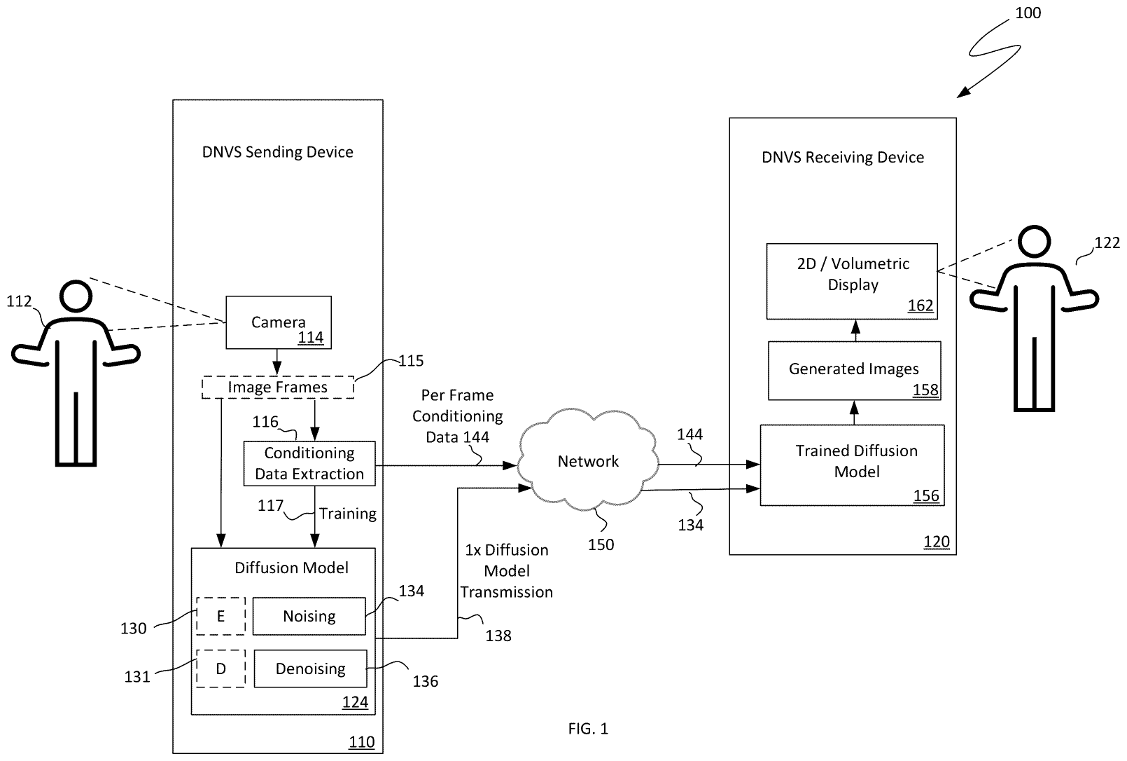

FIG. 1 illustrates a diffusion-based novel view synthesis (DNVS) communication system 100 in accordance with an embodiment. The system 100 includes a DNVS sending device 110 associated with a first user 112 and a DNVS receiving device 120 associated with a second user 122. During operation of the system 100 a camera 114 within the DNVS sending device 110 captures images 115 of an object or a static or dynamic scene. For example, the camera 114 may record a video including a sequence of image frames 115 of the object or scene. The first user 112 may or may not be appear within the image frames 115.

As shown, the DNVS sending device 110 includes a diffusion model 124 that is conditionally trained during a training phase. In one embodiment the diffusion model 124 is conditionally trained using image frames 115 captured prior to or during the training phase and conditioning data 117 derived from the training image frames by a conditioning data extraction module 116. The conditioning data extraction module 116 may be implemented using a solution such as, for example, MediaPipe Face Mesh, configured to generate 3D face landmarks from the image frames. However, in other embodiment the conditioning data 117 may include other data derived from the training image frames 115 such as, for example, compressed versions of the image frames, or canny edges derived from the image frames 115.

The diffusion model 124 may include an encoder 130, a decoder 131, a noising structure 134, and a denoising network 136. The encoder 130 may be a latent encoder and the decoder 131 may be a latent decoder 131. During training the noising structure 134 adds noise to the training image frames in a controlled manner based upon a predefined noise schedule. The denoising network 134, which may be implemented using a U-Net architecture, is primarily used to perform a “denoising” process during the training process pursuant to which noisy images corresponding to each step of the diffusion process are progressively refined to generate high-quality reconstructions of the training images 115.

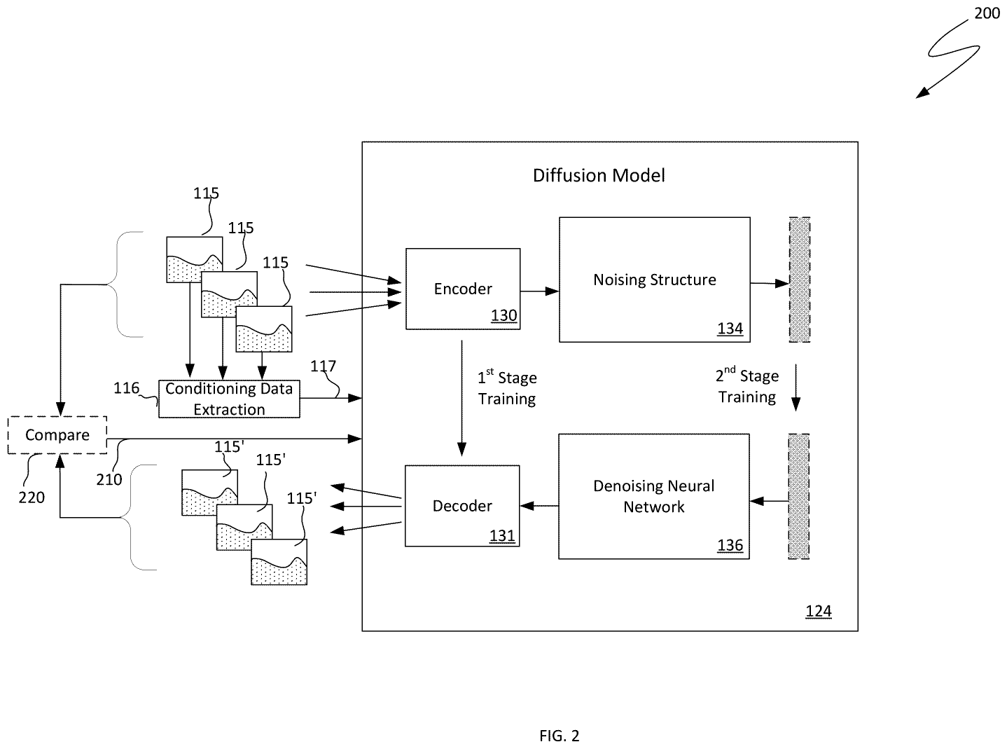

Reference is now made to FIG. 2, which illustrates a process 200 for conditionally training a diffusion model for use in diffusion-based communication in accordance with the disclosure. In one embodiment the encoder 130 and the decoder 131 of the diffusion model, which may be a generative model such as a version of Stable Diffusion, are initially trained using solely the training image frames 115 to learn a latent space associated with the training image frames 115. Specifically, the encoder 130 maps image frames 115 to a latent space and the decoder 131 generates reconstructed images 115′ from samples in that latent space. The encoder 130 and decoder 131 may be adjusted 210 during training to minimize differences identified by comparing 220 the reconstructed imagery 115′ generated by the decoder 131 and the training image frames 115.

After 1^{st} stage training of the encoder 130 and decoder 131, the combined diffusion model 124 (encoder 130, decoder 131, and diffusion stages 134, 136) may then be trained during a 2^{nd} stage using the image frames 115 acquired for training. During this training phase the model 124 is guided 210 to generate reconstructed images 115′ through the diffusion process that resemble the image frames 115. Depending on the specific implementation of the diffusion model 124, the conditioning data 117 derived from the image frames 115 during training can be applied at various stages of the diffusion process to guide the generation of reconstructed images. For example, the conditioning data 117 could be applied only to the noising structure 134, only to the denoising network 136, or to both the noising structure 134 and the denoising network 136.

In some embodiments the diffusion model 124 may have been previously trained using image other than the training image frames 115. In such cases it may be sufficient to perform only the 1^{st} stage training pursuant to which the encoder 130 and decoder 131 are trained to learn the latent space associated with the training image frames. That is, it may be unnecessary to perform the 2^{nd} stage training involving the entire diffusion model 124 (i.e., the encoder 130, decoder 131, noising structure 134, denoising network 136).

Referring again to FIG. 1, once training of the diffusion model 124 based upon the image frames 115 has been completed, model parameters 138 applicable to the trained diffusion model 124 are sent by the latent DNVS sending device 110 over a network 150 to the DNVS receiving device 120. The model parameters 138 (e.g., encoder/decoder parameters and neural network weights) are applied to a corresponding diffusion model architecture on the DNVS receiving device 120 to instantiate a trained diffusion model 156 corresponding to a replica of the trained diffusion model 124. In embodiments in which only the encoder 130 and decoder 131 are trained (i.e., only the 1^{st} stage training is performed), the model parameters 138 will be limited to parameter settings applicable to the encoder 130 and decoder 131 and can thus be communicated using substantially less data.

Once the diffusion model 124 has been trained and its counterpart trained model 156 established on the DNVS receiving device 120, generated images 158 corresponding to reconstructed versions of new image frames acquired by the camera 114 of the DNVS sending device 120 may be generated by the DNVS receiving device 120 as follows. Upon a new image frame 115 becoming captured by the camera 114, the conditioning data extraction module 116 extracts conditioning data 144 from the new image frame 115 and transmits the conditioning data 144 to the DNVS receiving device. The conditioning data 144 is provided to the trained diffusion model 156, which produces a generated image 158 corresponding to the new image 115 captured by the camera 114. The generated image 158 may then be displayed by a conventional 2D display or a volumetric display. It may be appreciated that because the new image 115 of a subject captured by the camera 114 will generally differ from training images 115 of the subject previously captured by the camera 114, the generated images 158 will generally correspond to “novel views” of the subject in that the trained diffusion model 156 will generally have been trained on the basis of training images 115 of the subject different from such novel views.

The operation of the system 100 may be further appreciated in light of the preceding discussion of the underpinnings of conditional diffusion for video communication and streaming in accordance with the disclosure. In the context of the preceding discussion, the parameter x corresponds to training image frame(s) 115 of a specific face in a lot of different expressions and a lot of different poses. This yields the unconditional diffusion model q(x) that approximates p(x). The parameter y corresponds to the 3D face mesh coordinates produced by the conditioning data extraction module 116 (e.g., MediaPipe, optionally to include body pose coordinates and even eye gaze coordinates), in the most basic form but may also include additional dimensions (e.g., RGB values at those coordinates). During training the conditioning data extraction module 116 produces y from x and thus we can train the conditional diffusion model q(y|x) that estimates p(y|x) using diffusion. Thus, we have everything we need to optimize the estimate of p(x|y) for use following training; that is, to optimize a desired fit or correspondence between conditioning data 144 (y) and a generated image 158 (x).

It may be appreciated that the conditioning data 144 (y) corresponding to an image frame 115 will typically be of substantially smaller size than the image frame 115. Accordingly, the receiving device 120 need not receive new image frames 115 to produce generated images 158 corresponding to such frames but need only receive the conditioning data 120 derived from the new frames 115. Because such conditioning data 144 is so much smaller in size than the captured image frames 115, the DNVS receiving device can reconstruct the image frames 115 as generated images 158 while receiving only a fraction of the data included within each new image frame produced by the camera 114. This is believed to represent an entirely new way of enabling reconstruction of versions of a sequence of image frames (e.g., video) comprised of relatively large amounts of image data from much smaller amounts of conditioning data received over a communication channel.

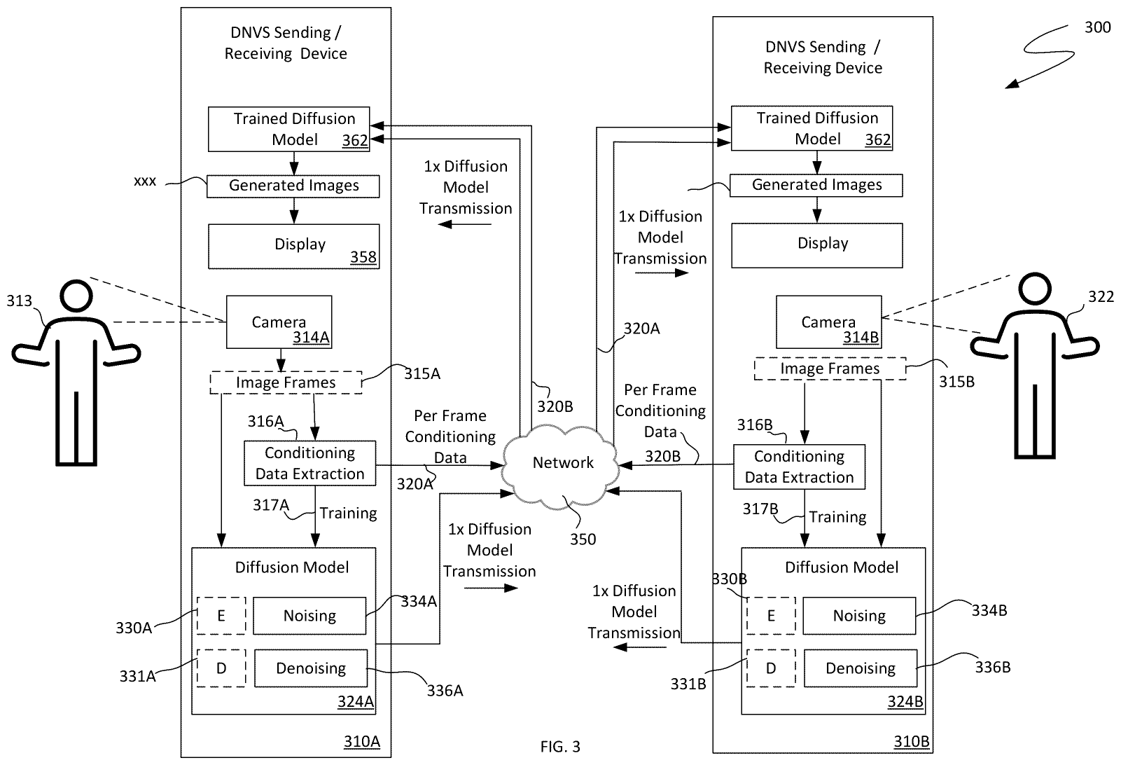

FIG. 3 illustrates another diffusion-based novel view synthesis (DNVS) communication system 300 in accordance with an embodiment. As may be appreciated by comparing FIGS. 1 and 3, the communication system 300 is substantially similar to the communication system 100 of FIG. 1 with the exception that a first user 312 is associated with a first DNVS sending/receiving device 310A and the second user 322 is associated with a second DNVS sending receiving device 310B. In the embodiment of FIG. 3 both the first DNVS sending/receiving device 310A and the second DNVS sending/receiving device 310B can generate conditionally training diffusion models 324 representative of an object or scene using training image frames 315 and conditioning data 317 derived from the training image frames 315. Once the diffusion models 324 on each device 310 are trained, weights defining the conditionally trained models 324 are sent (preferably one time) to the other device 310. Each device 310A, 310B may then reconstruct novel views of the object or scene modeled by the trained diffusion model 324 which it has received from the other device 310A, 310B in response to conditioning data 320A, 320B received from such other devices. For example, the first user 312 and the second user 322 could use their respective DNVS sending/receiving devices 310A, 310B to engage in a communication session during which each user 312, 322 could, preferably in real time, engage in video communication with the other user 312, 322. That is, each user 312, 322 could view a reconstruction of a scene captured the camera 314A. 314B of the other user based upon conditioning data 320A, 320B derived from an image frame 315A, 315B representing the captured scene, preferably in real time.

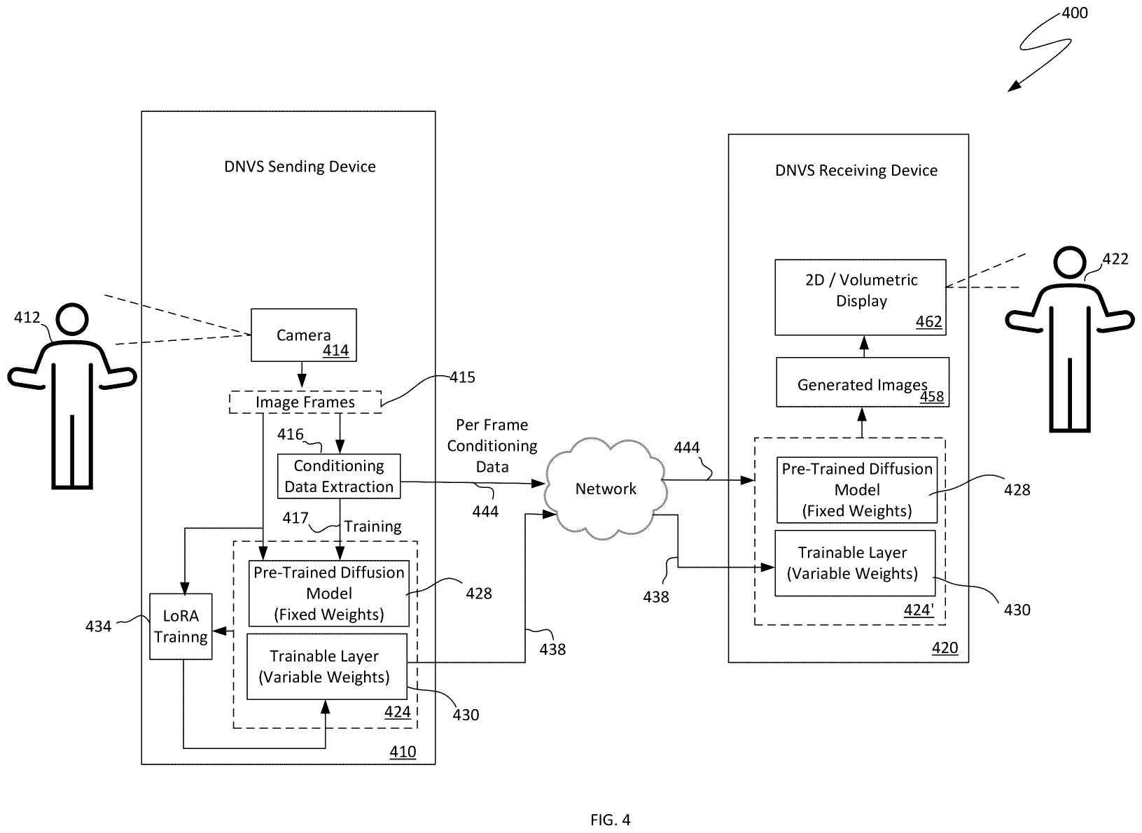

Attention is now directed to FIG. 4, which illustrates an alternative diffusion-based novel view synthesis (DNVS) communication system 400 in accordance with an embodiment. The system 400 includes a DNVS sending device 410 associated with a first user 412 and a DNVS receiving device 420 associated with a second user 422. During operation of the system 400 a camera 414 within the DNVS sending device 410 captures images 415 of an object or a static or dynamic scene. For example, the camera 414 may record a video including a sequence of image frames 415 of the object or scene. The first user 412 may or may not appear within the image frames 145.

As shown, the DNVS sending device 110 includes a diffusion model 424 consisting of a pre-trained diffusion model 428 and trainable layer 430 of the pre-trained diffusion model 428. In one embodiment the pre-trained diffusion model 428 may be a widely available diffusion model (e.g., Stable Diffusion or the like) that is pre-trained without the benefit of captured image frames 415. During a training phase the diffusion model 424 is conditionally trained through a low-rank adaptation (LoRA) process 434 pursuant to which weights within the trainable layer 430 are adjusted while weights of the pre-trained diffusion model 428 are held fixed. The trainable layer 430 may, for example, comprise a cross-attention layer associated with the pre-trained diffusion model 428; that is, the weights in such cross-attention layer may be adjusted during the training process while the remaining weights throughout the remainder of the pre-trained diffusion model 428 are held constant.

The diffusion model 424 is conditionally trained using image frames 415 captured prior to or during the training phase and conditioning data 417 derived from the training image frames by a conditioning data extraction module 416. Again, the conditioning data extraction module 416 may be implemented using a solution such as, for example, MediaPipe Face Mesh, configured to generate 3D face landmarks from the image frames. However, in other embodiment the conditioning data 417 may include other data derived from the training image frames 415 such as, for example, compressed versions of the image frames, or canny edges derived from the image frames 115.

When training the diffusion model 424 with the training image frames 415 and the conditioning data 417 only model weights 438 within the trainable layer 430 of the diffusion model 424 are adjusted. That is, rather than adjusting weights through the model 424 in the manner described with reference to FIG. 1, training of the model 424 is confined to adjusting weights 438 within the trainable layer 430. This advantageously results in dramatically less data being conveyed from the DNVS sending device 410 to the DNVS receiving device 420 to establish a diffusion model 424′ on the receiver 420 corresponding to the diffusion model 424. This is because only the weights 438 associated with the trainable layer 430, and not the known weights of the pre-trained diffusion model 428, are communicated to the receiver 420 at the conclusion of the training process.

Once the diffusion model 424 has been trained and its counterpart trained model 424′ established on the DNVS receiving device 420, generated images 458 corresponding to reconstructed versions of new image frames acquired by the camera 414 of the DNVS sending device 410 may be generated by the DNVS receiving device 420 as follows. Upon a new image frame 415 becoming captured by the camera 414. the conditioning data extraction module 416 extracts conditioning data 444 from the new image frame 415 and transmits the conditioning data 444 to the DNVS receiving device. The conditioning data 444 is provided to the trained diffusion model 424′, which produces a generated image 458 corresponding to the new image 415 captured by the camera 414. The generated image 458 may then be displayed by a conventional 2D display or a volumetric display 462. It may be appreciated that because the new image 415 of a subject captured by the camera 414 will generally differ from training images 415 of the subject previously captured by the camera 414, the generated images 458 will generally correspond to “novel views” of the subject in that the trained diffusion model 424′ will generally have been trained on the basis of training images 415 of the subject different from such novel views.

Moreover, although the trained diffusion model 424′ may be configured to render generated images 458 which are essentially indistinguishable to a human observer from the image frames 415, the pre-trained diffusion model 428 may also have been previously trained to introduce desired effects or stylization into the generated images 458. For example, the trained diffusion model 424′ (by virtue of certain pre-training of the pre-trained diffusion model 428) may be prompted to adjusting the scene lighting (e.g., lighten or darken) within the generated images 458 relative to the image frames 415 corresponding to such images 458. As another example, when the image frames 415 include human faces and the pre-trained diffusion model 428 has been previously trained to be capable of modifying human faces, the diffusion model 424′ may be prompted to change the appearance of human faces with within the generated images 458 (e.g., change skin tone, remove wrinkles or blemishes or otherwise enhance cosmetic appearance) relative to their appearance within the image frames 415. Accordingly, while in some embodiments the diffusion model 424′ may be configured such that the generated images 458 faithfully reproduce the image content within the image frames 415, in other embodiments the generated images 458 may introduce various desired image effects or enhancements.

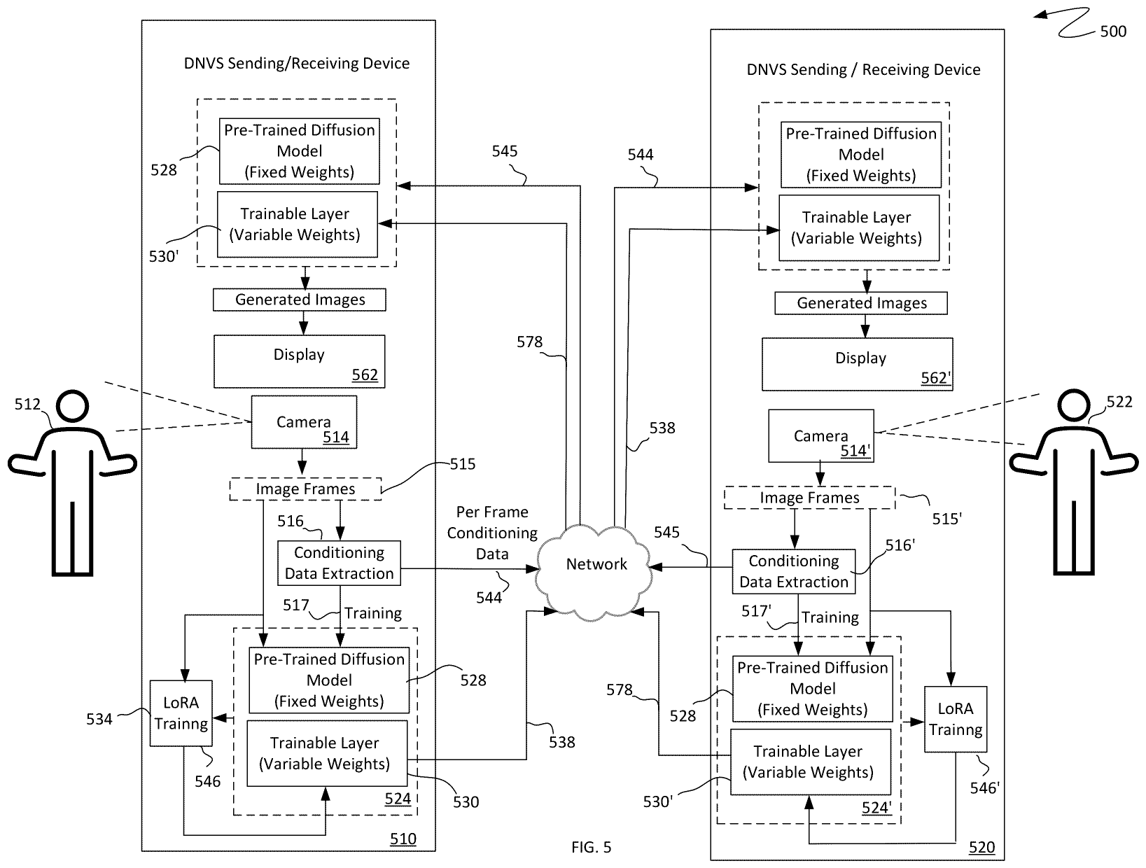

FIG. 5 illustrates another diffusion-based novel view synthesis (DNVS) communication system 500 in accordance with an embodiment. As may be appreciated by comparing FIGS. 4 and 5, the communication system 500 is substantially similar to the communication system 400 of FIG. 4 with the exception that a first user 512 is associated with a first DNVS sending/receiving device 510 and a second user 522 is associated with a second DNVS sending receiving device 520. In the embodiment of FIG. 5 both the first DNVS sending/receiving device 510 and the second DNVS sending/receiving device 520 can generate conditionally training diffusion models 524, 524′ representative of an object or scene using training image frames 515 and conditioning data 517 derived from the training image frames 515. Once the diffusion models 524 on each device 510, 520 are trained, weights 538, 578 for the trainable layers 530, 530′ of the conditionally trained models 524, 524′ are sent to the other device 510, 520. Updates to the weights 538, 578 may optionally be sent following additional LoRA-based training using additional training image frames 515, 515′. Each device 510, 520 may then reconstruct novel views of the object or scene modeled by the trained diffusion model 524, 524′ which it has received from the other device 510, 520 in response to conditioning data 544, 545 received from such other device. For example, the first user 512 and the second user 522 could use their respective DNVS sending/receiving devices 510, 520 to engage in a communication session during which each user 512, 522 could, preferably in real time, engage in video communication with the other user 512, 522. That is, each user 512, 522 could view a reconstruction of a scene captured the camera 514, 514′ of the other user based upon conditioning data 544, 545 derived from an image frame 515, 515′ representing the captured scene, preferably in real time.

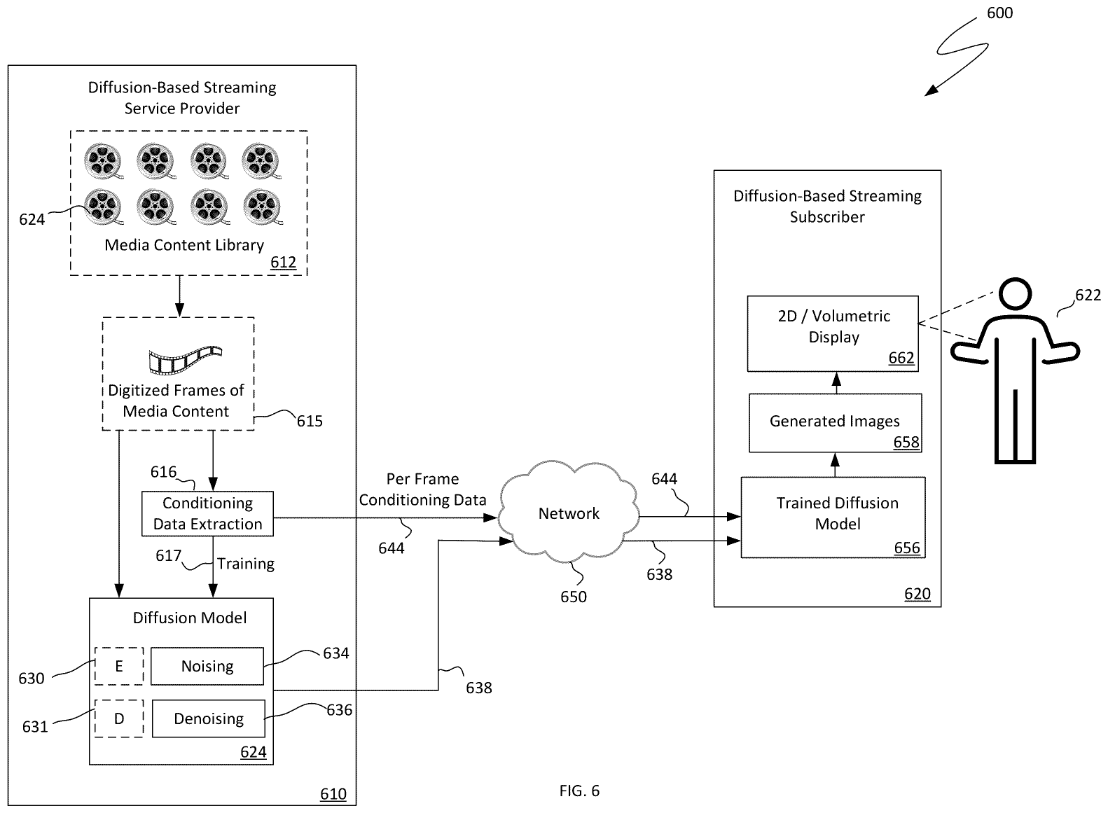

FIG. 6 illustrates a diffusion-based video streaming and compression system 600 in accordance with an embodiment. The system 600 includes a diffusion-based streaming service provider facility 610 configured to efficiently convey media content from a media content library 612 to diffusion-based streaming subscriber device 620. As shown, the diffusion-based streaming service provider facility 610 includes a diffusion model 624 that is conditionally trained during a training phase. In one embodiment the diffusion model 624 is conditionally trained using (i) digitized frames of media content 615 from one or more media files 624 (e.g., video files) included within the content library 612 and (ii) conditioning data 617 derived from image frames within the media content by a conditioning data extraction module 616. The conditioning data extraction module 616 may be configured to, for example, generate compressed versions of the image frames within the media content, derive canny edges from the image frames, or otherwise derive representations of such image frames containing substantially less data than the image frames themselves.

The diffusion model 624 may include an encoder 630, a decoder 631, a noising structure 634, and a denoising network 636. The encoder 630 may be a latent encoder and the decoder 631 may be a latent decoder 631. The diffusion model 624 may be trained in substantially the same manner as was described above with reference to training of the diffusion model 124 (FIGS. 1 and 2); provided, however, that in the embodiment of FIG. 6 the training information is comprised of the digitized frames of media content 615 (e.g., all of the video frames in a movie or other video content) and the conditioning data 617 associated with each digitized frame 615.

Referring again to FIG. 6, once training of the diffusion model 624 based upon the digitized frames of media content 615 has been completed, model parameters 638 applicable to the trained diffusion model 624 are sent by the streaming service provider facility 610 over a network 650 to the streaming subscriber device 620. The model parameters 638 (e.g., encoder/decoder parameters) are applied to a corresponding diffusion model architecture on the streaming subscriber device 620 to instantiate a trained diffusion model 656 corresponding to a replica of the trained diffusion model 624.

Once the diffusion model 624 has been trained and its counterpart trained model 656 established on the streaming subscriber device 620, generated images 658 corresponding to reconstructed versions of digitized frames of media content may be generated by the streaming subscriber device 620 as follows. For each digitized media content frame 615, the conditioning data extraction module 616 extracts conditioning data 644 from the media content frame 615 and transmits the conditioning data 644 to the streaming subscriber device 620. The conditioning data 644 is provided to the trained diffusion model 656, which produces a generated image 658 corresponding to the media content frame 615. The generated image 658 may then be displayed by a conventional 2D display or a volumetric display. It may be appreciated that because the amount of conditioning data 644 generated for each content frame 615 is substantially less than the amount of image data within each content frame 615, a high degree of compression in obtained by rendering images 658 corresponding to reconstructed versions of the content frames 615 in this manner.

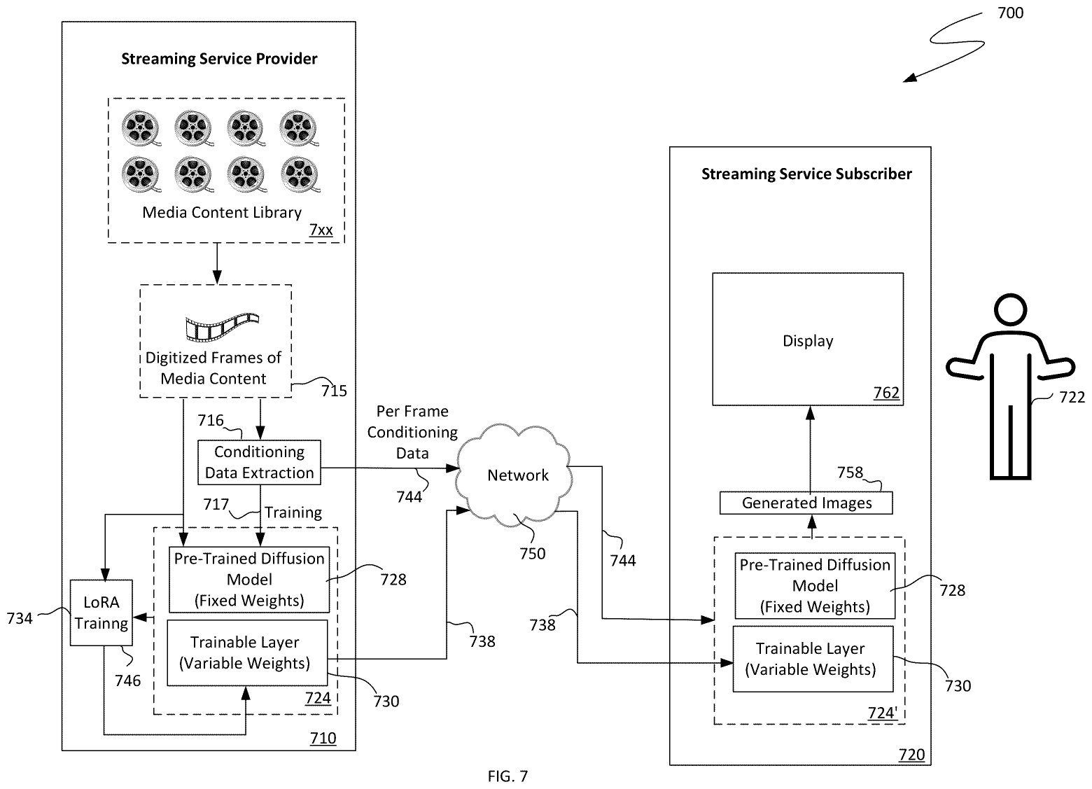

FIG. 7 illustrates a diffusion-based video streaming and compression system 600 in accordance with another embodiment. The system 700 includes a diffusion-based streaming service provider facility 710 configured to efficiently convey media content from a media content library 712 to diffusion-based streaming subscriber device 720. As shown, the diffusion-based streaming service provider facility 710 includes a diffusion model 724 that is conditionally trained during a training phase. In one embodiment the diffusion model 724 is conditionally trained using (i) digitized frames of media content 715 from one or more media files 724 (e.g., video files) included within the content library 712 and (ii) conditioning data 717 derived from image frames within the media content by a conditioning data extraction module 716. The conditioning data extraction module 716 may be configured to, for example, generate compressed versions of the image frames within the media content, derive canny edges from the image frames, or otherwise derive representations of such image frames containing substantially less data than the image frames themselves.

As shown, the diffusion model 724 includes a pre-trained diffusion model 728 and trainable layer 730 of the pre-trained diffusion model 728. In one embodiment the pre-trained diffusion model 728 may be a widely available diffusion model (e.g., Stable Diffusion or the like) that is pre-trained without the benefit of the digitized frames of media content 715. During a training phase the diffusion model 724 is conditionally trained through a low-rank adaptation (LoRA) process 734 pursuant to which weights within the trainable layer 730 are adjusted while weights of the pre-trained diffusion model 728 are held fixed. The trainable layer 730 may, for example, comprise a cross-attention layer associated with the pre-trained diffusion model 728; that is, the weights in such cross-attention layer may be adjusted during the training process while the remaining weights throughout the remainder of the pre-trained diffusion model 728 are held constant. The diffusion model 724 may be trained in substantially the same manner as was described above with reference to training of the diffusion model 424 (FIG. 4); provided, however, that in the embodiment of FIG. 7 the training information is comprised of the digitized frames of media content 715 (e.g., all of the video frames in a movie or other video content) and the conditioning data 717 associated with each digitized frame 715.

Because during training of the diffusion model 724 only the model weights 738 within the trainable layer 730 of the diffusion model 724 are adjusted, a relatively small amount of data is required to be conveyed from the streaming facility 710 to the subscriber device 720 to establish a diffusion model 724′ on the subscriber device 720 corresponding to the diffusion model 724. Specifically, only the weights 738 associated with the trainable layer 730, and not the known weights of the pre-trained diffusion model 728, need be communicated to the receiver 720 at the conclusion of the training process.

Once the diffusion model 724 has been trained and its counterpart trained model 724′ have been established on the streaming subscriber device 720. generated images 758 corresponding to reconstructed versions of digitized frames of media content may be generated by the streaming subscriber device 720 as follows. For each digitized media content frame 715, the conditioning data extraction module 716 extracts conditioning data 744 from the media content frame 715 and transmits the conditioning data 744 to the streaming subscriber device 720. The conditioning data 744 is provided to the trained diffusion model 724′, which produces a generated image 758 corresponding to the media content frame 715. The generated image 758 may then be displayed by a conventional 2D display or a volumetric display 762. It may be appreciated that because the amount of conditioning data 744 generated for each content frame 715 is substantially less than the amount of image data within each content frame 715, the conditioning data 744 may be viewed as a highly compressed version of the digitized frames of media content 715.

Moreover, although the trained diffusion model 724′ may be configured to render generated images 758 which are essentially indistinguishable to a human observer from the media content frames 715, the pre-trained diffusion model 728 may also have been previously trained to introduce desired effects or stylization into the generated images 758. For example, the trained diffusion model 724′ may (by virtue of certain pre-training of the pre-trained diffusion model 728) be prompted to adjusting the scene lighting (e.g., lighten or darken) within the generated images 758 relative to the media content frames 715 corresponding to such images. As another example, when the media content frames 715 include human faces and the pre-trained diffusion model 728 has been previously trained to be capable of modifying human faces, the diffusion model 724′ may be prompted to change the appearance of human faces with within the generated images 758 (e.g., change skin tone, remove wrinkles or blemishes or otherwise enhance cosmetic appearance) relative to their appearance within the media content frames 715. Accordingly, while in some embodiments the diffusion model 724′ may be configured such that the generated images 758 faithfully reproduce the image content within the media content frames 715, in other embodiments the generated images 758 may introduce various desired image effects or enhancements.

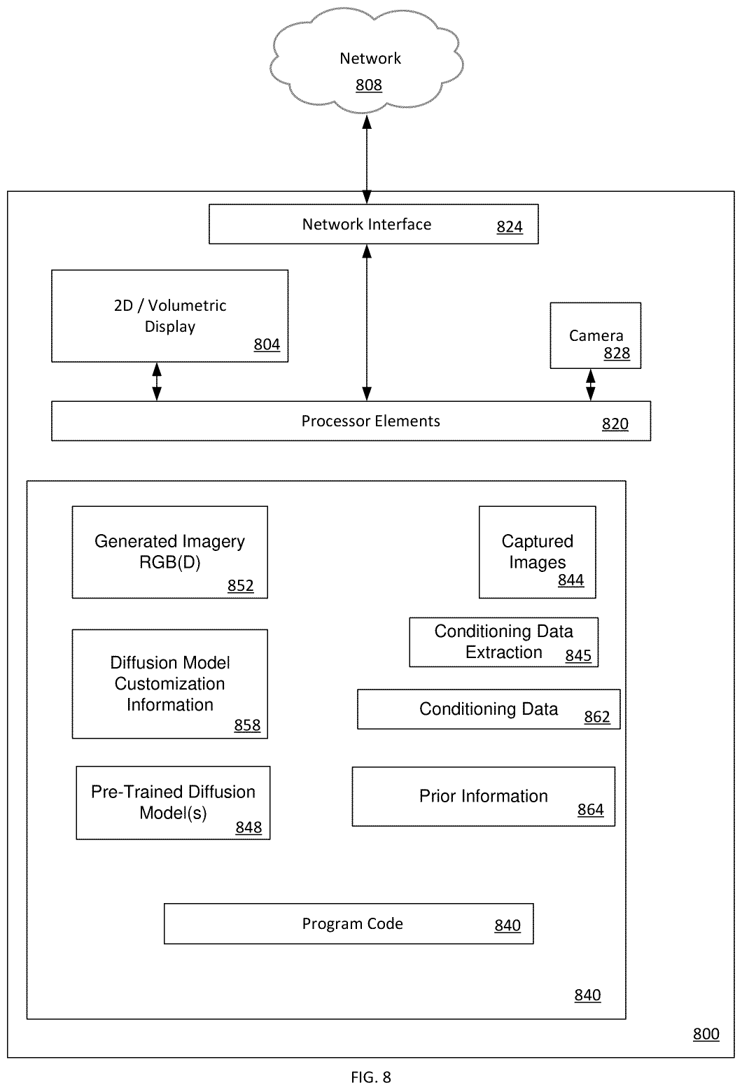

Attention is now directed to FIG. 8, which includes a block diagram representation of an electronic device 800 configured to operation as a DNVS sending and/or DNVS receiving device in accordance with the disclosure. It will be apparent that certain details and features of the device 800 have been omitted for clarity. The device 800 may be in communication with another DNVS sending and receiving device (not shown) via a communications link which may include, for example, the Internet, the wireless network 808 and/or other wired or wireless networks. The device 800 includes one or more processor elements 820 which may include, for example, one or more central processing units (CPUs), graphics processing units (GPUs), neural processing units (NPUs), neural network accelerators (NNAs), application specific integrated circuits (ASICs), and/or digital signal processors (DSPs). As shown, the processor elements 820 are operatively coupled to a touch-sensitive 2D/volumetric display 804 configured to present a user interface 208. The touch-sensitive display 804 may comprise a conventional two-dimensional (2D) touch-sensitive electronic display (e.g., a touch-sensitive LCD display). Alternatively, the touch-sensitive display 804 may be implemented using a touch-sensitive volumetric display configured to render information bolographically. See, e.g., U.S. Patent Pub. No. 20220404536 and U.S. Patent Pub. No. 20220078271. The device 800 may also include a network interface 824, one or more cameras 828, and a memory 840 comprised of one or more of, for example, random access memory (RAM), read-only memory (ROM), flash memory and/or any other media enabling the processor elements 820 to store and retrieve data. The memory 840 stores program code 840 and/or instructions executable by the processor elements 820 for implementing the computer-implemented methods described herein.

The memory 840 is also configured to store captured images 844 of a scene which may comprise, for example, video data or a sequence of image frames captured by the one or more cameras 828. A conditioning data extraction module 845 configured to extract or otherwise derive conditioning data 862 from the captured images 844 is also stored. The memory 840 may also contain information defining one or more pre-trained diffusion models 848, as well as diffusion model customization information for customizing the pre-trained diffusion models based upon model training of the type described herein. The memory 840 may also store generated imagery 852 created during operation of the device as a DNVS receiving device. As shown, the memory 840 may also store various prior information 864.

### Use of Low-Rank Adaptation (LoRA) Training in Video Communication and Streaming

In another aspect the disclosure proposes an approach for drastically reducing the overhead associated with diffusion-based compression techniques. The proposed approach involves using low-rank adaptation (LoRA) weights to customize diffusion models. Use of LoRA training results in several orders of magnitude less data being required to be pre-transmitted to a receiver at the initiation of a video communication or streaming session using diffusion-based compression. Using LoRA techniques a given diffusion model may be customized by modifying only a particular layer of the model while generally leaving the original weights of the model untouched. As but one example, the present inventors have been able to customize a Stable Diffusion XL model (10 GB) with a LoRA update (45 MB) to make a custom diffusion model of an animal (i.e., a pet dog) using a set of 9 images of the animal.

In a practical application a receiving device (e.g., a smartphone, tablet, laptop or other electronic device) configured for video communication or rendering streamed content would already have a standard diffusion model previously downloaded (e.g., some version of Stable Diffusion or the equivalent). At the transmitter, the same standard diffusion model would be trained using LoRA techniques on a set of images (e.g., on photos or video of a video communication participant or on the frames of pre-existing media content such as, for example, a movie or a show having multiple episodes). Once the conditionally trained diffusion model has been sent to the receiver by sending a file of the LoRA customizing weights, it would subsequently only be necessary to transmit LoRA differences used to perform conditional diffusion decoding. This approach avoids the cost of sending a custom diffusion model from the transmitter to the receiver to represent each video frame (as well as the cost of training such a diffusion model from scratch in connection with each video frame).

In some embodiments the above LoRA-based conditional diffusion approach could be enhanced using dedicated hardware. For example, one or both of the transmitter and receiver devices could store the larger diffusion model (e.g., which could be on the order of (10 GB)) on an updateable System on a Chip (SoC), thus permitting only the conditioning data metadata and LoRA updates in a much smaller file (e.g., 45 MB or less).

Some video streams may include scene/set changes that can benefit from further specialization of adaptation weights (e.g., LoRA). Various types of scene/set changes could benefit from such further specialization:
A scene that evolves gradually: e.g., subjects in motion
A scene that changes abruptly: e.g., a scene or set change.
A video stream may also alternate between sets.

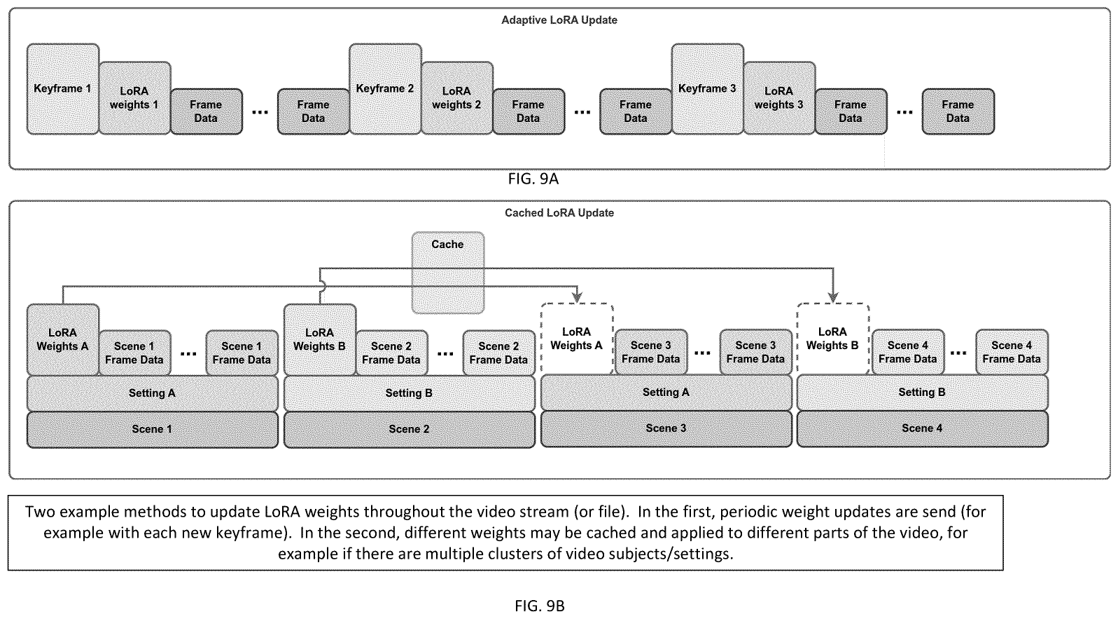

FIGS. 9A and 9B illustrate approaches for further specialization of adaptation weights. The exemplary methods of FIGS. 9A and 9B involve update LoRA weights throughout the video stream (or file) being transmitted. In the approach of FIG. 9A, periodic weight updates are sent (for example with each new keyframe). In the approach of FIG. 9B, different weights may be cached and applied to different parts of the video, for example if there are multiple clusters of video subjects/settings.

Referring to FIG. 9A in more detail, as the LoRA weights are very small relative to image data, new weights could be sent frequently (e.g., with each keyframe), allowing the expressive nature of the diffusion model to evolve over time. This allows a video to be encoded closer to real time as it avoids the latency required to adapt to the entire video file. This has the additional benefit that if a set of weights is lost (e.g., due to network congestion), the quality degradation should be small until the next set of weights is received. An additional benefit is that the new LoRA weights may be initialized with the previous weights, thus reducing computational burden of the dynamic weight update at the transmitter. In a holographic chat scenario, the sender may periodically grab frames (especially frames not seen before) and update the LoRA model that is then periodically transmitted to the recipient, thus over time the representative quality of the weights continues to improve.

Turning now to FIG. 9B, as a video stream may alternate between multiple sets and subjects, we may also dynamically send new LoRA weights as needed. This could be determined adaptively when a frame shows dramatic changes from previous scenes (e.g., in the latent diffusion noise realization), or when the reconstruction error metric (e.g., PSNR) indicates loss of encoding quality.

As is also indicated in FIG. 9B, we may also cache these weights and reference previous weights. For example, one set of weights may apply to one set of a movie, whereas a second set of weights to a second set. As the scenes change back and forth, we may refer to those previously transmitted LoRA weights.

### Additional Prompt Guidance for Conditional Diffusion

A standard presentation of conditional diffusion includes the use of an unconditional model, combined with additional conditional guidance. For example, in one approach the guidance may be a dimensionality reduced set of measurements and the unconditional model is trained on a large population of medical images. See, e.g., Song, et al. “Solving Inverse Problems in Medical Imaging with Score-Based Generative Models”; arXiv preprint arXiv:2111.08005 [eess.IV] (Jun. 16, 2022). With LoRA, we have the option of adding additional guidance to the unconditional model. Some examples

We may replace the unconditional model with a LoRA-adapted model using the classifier-free-guidance method (e.g., StableDiffusion). In this case, we would not provide a fully unconditional response, but we would instead at a minimum provide the general prompt (or equivalent text embedding). For example, when specializing with dreambooth, the customization prompt may be “a photo of a <placeholder> person”, where “<placeholder>” is a word not previously seen. When running inference we provide that same generic prompt as additional guidance. This additional guidance may optionally apply to multiple frames, whereas the other information (e.g., canny edges, face mesh landmarks) are applied per-frame.

We may also infer (or solve for) the text embedding (machine-interpretable code produced from the human-readable prompt) that best represents the image.

We may also provide a noise realization from either:
the noise state from a run of the forward process,
inference (solve for) the best noise realization that produced the given text (e.g., via backpropagation),
inference (solve for) the random number generator (RNG) seed that produced the noise state

Finally, if we transmit noise we may structure that noise to further compress the information, some options include:
imposing sparsity on the noise realization (e.g., mostly zeros) and compress that information before transmitting (e.g., only send the values and location of the non-zero values),
use a predictable noise sequence (e.g., a PN sequence) that best initializes the data, as a maximal-length PN sequence may be compactly represented by only the state of the generator (e.g., a linear-feedback shift register).

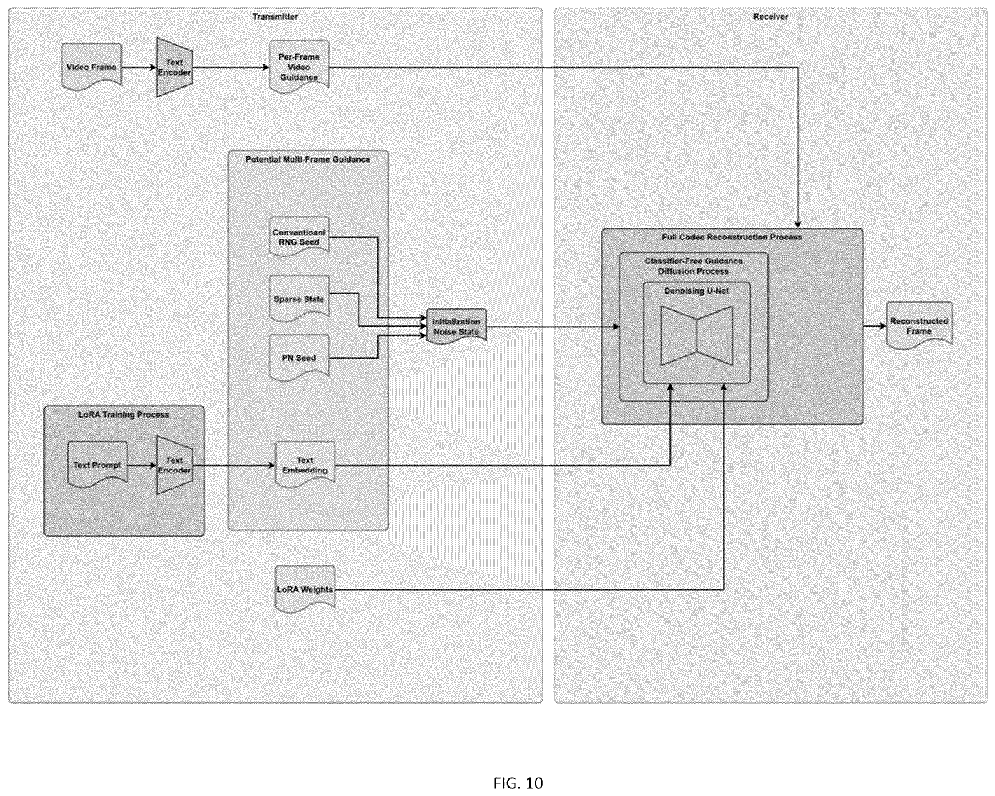

FIG. 10 illustrates an exemplary adapted diffusion codec process. Guidance to reconstruct the image is shown in purple. Additional forms of guidance (including multi-frame) guidance that further leverage the LoRA process are shown in red.

More recent (and higher resolution) diffusion models (e.g., StableDiffusion XL) may use both a denoiser network and a refiner network. In accordance with the disclosure, the refiner network is adapted with LoRA weights, and those weights are potentially used to apply different stylization, while the adapted denoiser weights apply personalization. Various innovations associated with this process include:
Applying adaptation networks (e.g., LoRA) to any post-denoising refiner networks
Applying adaptation to either or both
Optionally, apply stylization to the refiner network while the denoiser network handles primary customization
   e.g., having a style for business (realistic representation, professional attire, well-groomed) and personal (more fun attire, hair color, or more fantastical appearance)

### Real-Time Diffusion

When applying the diffusion methods herein to real-time video, one problem that arises is real time rendering given that a single frame would currently require at least several seconds if each frame is generated at the receive from noise. Modern denoising diffusion models typically slowly add noise to a target image with a well-defined distribution (e.g., Gaussian) to transform it from a structured image to noise in the forward process, allowing a ML model to learn the information needed to reconstruct the image from noise in the reverse process. When applied to video this would require beginning each frame from a noise realization and proceeding with several (sometimes 1000+) diffusion steps. This is computationally expensive, and that complexity grows with frame rate.

One approach in accordance with the disclosure recognizes that the previous frame may be seen as a noisy version of the subsequent frame and thus we would rather learn a diffusion process from the previous frame to the next frame. This approach also recognizes that as the frame rate increases, the change between frames decreases, and thus the diffusion steps required in between frames would reduce, and thus counterbalances the computational burden introduced by additional frames.

The most simplistic version of this method is to initialize the diffusion process of the next frame with the previous frame. The denoiser (which may be specialized for the data being provided) simply removes the error between frames. Note that the previous frame may itself be derived from its predecessor frame, or it may be initialized from noise (a diffusion analog to a keyframe)

A better approach is to teach the denoiser to directly move between frames, not simply from noise. The challenge is that instead of moving from a structured image to an unstructured image using noise that is well modeled (statistically) each step, we must diffuse from one form of structure to the next. In standard diffusion the reverse process is only possible because the forward process is well defined. This approach uses two standard diffusion models to train a ML frame-to-frame diffusion process. The key idea is to run the previous frame (which has already been decoded/rendered) in the forward process but with a progressively decreasing noise power and the subsequent frame in the reverse process with a progressively increasing noise power. Using those original diffusion models, we can provide small steps between frames, which can be learned with a ML model (such as the typical UNet architecture). Furthermore, if we train this secondary process with score-based diffusion (employing differential equations), we may also interpolate in continuous time between frames.

Once trained, the number of diffusion steps between frames may vary. The number of diffusion steps could vary based on the raw framerate, or it could dynamically change based on changes in the image. In both the total number of iterations should typically approach some upper bound, meaning the computation will be bounded and predictable when designing hardware. That is, with this approach it may be expected that as the input framerate increases, the difference between frames would decrease, thus requiring fewer diffusion iterations. Although the number of diffusion calls would grow with framerate, the number of diffusion iterations may reduce with framerate, leading to some type of constant computation or lower bound behavior. This may provide “bullet time” output for essentially no additional computational cost.

Additionally, the structured frame may itself be a latent representation. This includes the variational autoencoders used for latent diffusion approaches, or it may be the internal representation of a standard codec (e.g., H.264).

As this method no longer requires the full forward denoising diffusion process. we may also use this method to convert from a low-fidelity frame to a high-fidelity reconstruction (see complementary diffusion compression discussion below). A frame that is intentionally low-fidelity (e.g., low-pass filtered) will have corruption noise that is non-gaussian (e.g., spatially correlated), and thus this method is better tuned to the particular noise introduced.

Although not necessary to implement the disclosed technique for real-time video diffusion, we have recognized that the previous frame may be viewed as a noisy version of the subsequent frame. Consequently, the denoising U-Nets may be used to train an additional UNet which does not use Gaussian noise as a starting point. Similar opportunities exist for volumetric video. Specifically, even in the absence of scene motion, small changes occur in connection with tracked head motion of the viewer. In this sense the previous viewing angle may be seen as a noisy version of subsequent viewing angles, and thus a similar structure-to-structure UNet may be trained.

In order to improve the speed of this process, we may use sensor information to pre-distort the prior frame, e.g., via a low-cost affine Homomorphic transformation, which should provide an even closer (i.e., lower noise) version of the subsequent frame. We may also account for scene motion by using feature tracking and combining with a more complex warping function (e.g., a thin-plate spline warping).

Finally, this technique need not be applied exclusively to holographic video. In the absence of viewer motion (i.e., holographic user head position changes), the scene may still be pre-distorted based on the same feature tracking described above.

Various innovations associated with this process include:
In holographic video, previous viewing angles may be seen as noisy versions of subsequent viewing angles and thus we may apply the same structure-to-structure UNet training as we did with time, but now as a function of angle.
   We may combine this with dynamic scenes such that we train a UNet to adapt to both space and time.
Whether we are tracking scene motion or head motion, we may further pre-distort the previous frame image based on additional data to provide a diffusion starting point that is closer to the subsequent frame (i.e., lower initial noise).
   We may use feature tracking to compute scene changes
   We may use accelerometer information or pose estimated from features/fiducial markers to estimate head motion
   We may then apply affine transformations or more complex warping such as thin plate splines to predistort
   This may work with scene motion only, viewer motion only, or both motions, thus it may be applied to both 2D and 3D video diffusion

In the previous section, the use of splines was mentioned as a way of adjusting the previous frame to be a better initializer of the subsequent frame. The goal of that processing was higher fidelity and faster inference time. However, the warping of input imagery may also serve an additional purpose. This is particularly useful when an outer autoencoder is used (as is done with Stable Diffusion), as that can struggle to faithfully reproduce hands and faces when they do not occupy enough of the frame. Using a warping function, we may devote more pixels to important areas (e.g., hands and face) at the expense of less-important features. Note we are not proposing masking cropping and merging, but a more natural method that does not require an additional run

Furthermore, there are additional benefits beyond just faithful human feature reconstruction. We may simply devote more latent pixels to areas of the screen in focus at the expense of those not in focus. This would not require human classification. Note that “in-focus” areas may be determined by a Jacobian calculation (as is done with ILC cameras). While this may improve the fidelity of the parts the photographer/videographer “cares” about, this may also allow a smaller size image to be denoised with the same quality, thus improving storage size and training/inference time. It is likely that use of LoRA customization on a distorted frame (distorted prior to VAE encoder) will produce better results.

Various innovations associated with this process include:
Naturally distort an image based on important features detected (e.g., hands, face) to improve perceptual inference quality
   use a complex spline (e.g., thin-pate-spline) to avoid needing to mask, join or run diffusion multiple times
Naturally distort an image based on in-focus (or areas with high sharpness or detail) at the expense of low-frequency areas (e.g., smooth walls, or areas out of focus).
   we may determine this via a Jacobian or other measure of sharpness on the latent pixels
   this will naturally improve image quality to faces and hands (presuming they are in focus by the photographer)
   this will naturally improve overall image quality
   this may also allow us to use smaller image resolution (improving computation time)
We may combine this with LoRA customization
   apply the distortion outside of the VAE autoencoder then use LoRA to work with distorted images

### Video Diffusion Complementary to Conventional Video Compression

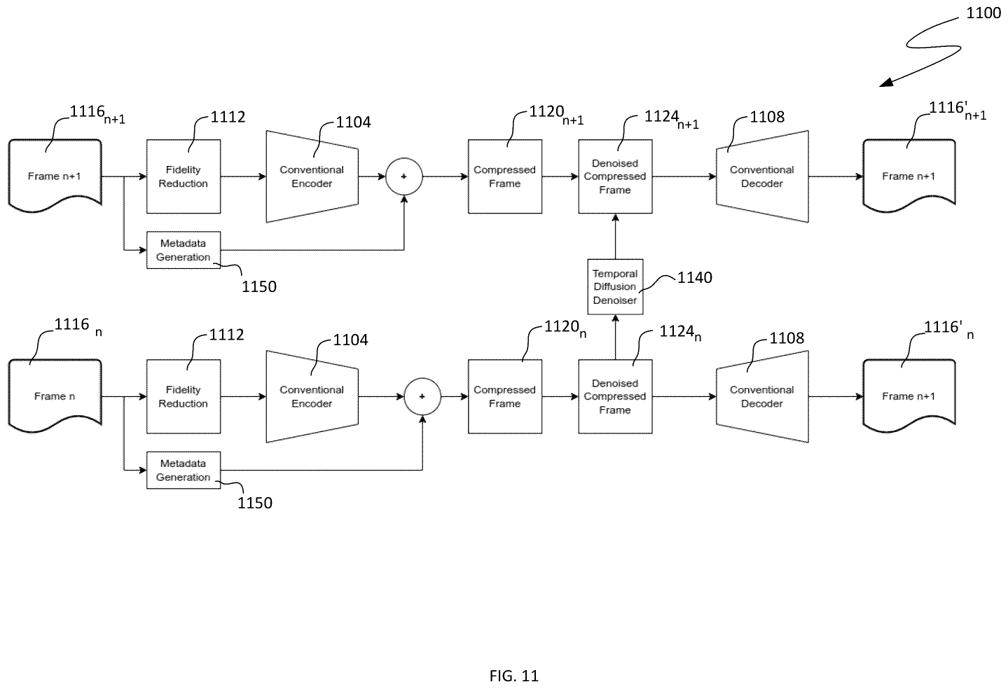

Attention is now directed to FIG. 11, which illustrates an exemplary process 1100 flow for the use of video diffusion complementary to conventional video compression in accordance with the disclosure. The process 1100 is designed to enable video diffusion to be used to complement existing video codecs (e.g., H.264 codecs), such codecs being comprised of a coder 1104 and a corresponding decoder 1108. Specifically, the process 1100 leverages the codebase (widely used and optimized on a variety of devices) and features (e.g., keyframe management) of existing codecs. The method involves reducing 1112 the information content of frames 1116 of the incoming video signal to be compressed (e.g., by low-pass filtering), which should result in a smaller (but lower-fidelity) conventionally encoded file comprised of compressed frames 1120. A diffusion methodology is then relied upon to reconstruct the conventionally encoded file into denoised compressed frames 1124. The denoised compressed frames 1124 may then be conventionally decoded to yield reconstructed frames 1116′ corresponding to the incoming video frames 1116.

In some embodiments the compressed frames 1120 may be transmitted from, for example, a sending device or streaming facility to a receiving device or subscriber device. Within such receiving or subscriber device the compressed frames 1120 may be provided to a denoiser. Such a denoiser will have been previously trained in accordance with the video diffusion methodology described above with reference to FIGS. 1-10 to remove the errors introduced by the fidelity reduction 1112. The denoised compressed frames 1124 produced by the denoiser are then decoded by the conventional decoder 1108 to yield the yield reconstructed frames 1116′.

It may be appreciated that the approach of FIG. 11 complements rather than replaces the processing of a conventional codec (e.g., H.264). The corruption (e.g., low-pass-filtering) or other fidelity reduction 1112 introduced before the conventional encoder 1104 reduces the fidelity of the imagery 1116 input to the conventional encoder 1104 and thus decreases the bandwidth of the compressed signal comprised of the compressed frames 1120. The resulting “error” in the compressed frames 1120 introduced by the fidelity reduction 1112 is then corrected using a diffusion model that has been previously trained on images corrupted by the fidelity reduction 1112. This approach retains all the benefits of a conventional compression algorithm (e.g., motion estimation, keyframe generation, etc.), and may also utilize existing software (e.g., H.264) that is adapted and used on a wide range of hardware.

This lower fidelity conversion implemented by the fidelity reduction operation 1112 may be low loss (e.g., a variational autoencoder), or it may be higher loss (e.g., low-pass filtering). It may also occur pre-conventional encoding or on the post-conventional encoder compressed output. Note that a simple spatial low-pass filter algorithm increases the spatial redundancy, and thus increases the compression ability of the conventional encoder 1104. This redundancy may optionally be introduced in time, e.g., temporal filtering.

As the errors introduced by fidelity reduction are unlikely to be very Gaussian in nature (a common model used for diffusion model denoisers), we may tune the denoiser to the particular corruption introduced using the video diffusion methodology described above with reference to FIGS. 1-10. We may also use the above-described video diffusion methods to train a denoiser 1140 designed to work between adjacent compressed frames 1124 to further reduce computation burden at the decoder 1108.

Note that the embodiment of FIG. 11 is not restricted to utilizing information in the video stream. Although FIG. 11 indicates that additional metadata 1150 (e.g., face mesh coordinates) is transmitted in the video stream containing the compressed frames 1120, in other embodiments the additional metadata 1150 may be transmitted in a side channel. If it desirable to send metadata 1150 but still fully conform with the conventional encoder file format, this side channel information may alternatively be embedded in the data stream including the compressed frames 1120 (either pre-conventional or post-conventional compression). In one exemplary approach a steganography method is employed in which the least-significant bit of the image stream carries this metadata 1150 information, and we rely (as before) on the diffusion model to denoise this extra corruption.

This approach of FIG. 11 is not restricted to compression using H.264 protocols. In other embodiments video diffusion may be used as a complement to a simpler algorithm such as Motion JPEG (MJPEG). In this case the sparse frequency domain representation may be converted back to the image domain prior to diffusion-based denoising, and thus is applied after the conventional decoder.

### Parallel Denoising Diffusion

### Introduction

An analysis of diffusion changes occurring at each denoising iteration during exemplary diffusion processes has been undertaken. This analysis has unexpectedly revealed that the changes per iteration are not uniform over all numerical values, including bit values (as each pixel is represented by an 8-bit unsigned integer). In particular, the changes per bit have been found to be sparse, meaning only a few bits are changed per iteration, which is inefficient as diffusion is inherently a sequential operation. In accordance with the disclosure, the inventors have recognized that this inefficiency may provide an opportunity to speed up and/or parallelize diffusion for codec purposes. If each bit is individually represented in the denoiser, having each bit diffuse independently may allow parallelization opportunities and thus decrease iterations (and denoising latency).

Motivated in part by this analysis of exemplary diffusion processes, disclosed herein is a method to parallelize the diffusion process by representing ranges of values (or individual bits) by separate variables (which may be floating-point-valued) that are denoised. The overall effect may be to increase the overall input data size, but it may also decrease this size. The nonlinearity on the individual bits makes this formulation distinctly different than simply a precision change. The bit-level representation allows individual bits (or ranges of values from the input pixel) to be separately denoised and thus reduce overall iterations as current state-of-the-art often does not change all pixels uniformly.

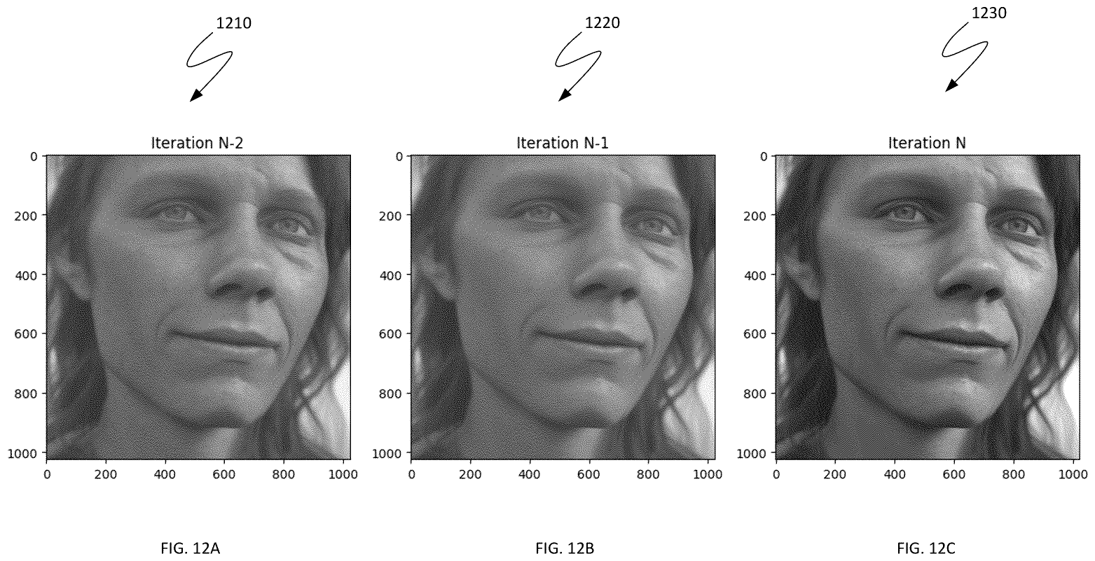

Turning now to FIGS. 12A-12C, which depict a group of example images 1210, 1220, 1230 generated by a conventional diffusion model after various numbers of training iterations in response to a text prompt. Specifically, the images 1210, 1220, 1230 of FIGS. 12A-12C were generated using StableDiffusion (SDXL 1.0) configured with its standard (non-LoRA adapted) weights. No refiner was used, and as 16-bit floating-point precision was used, a half-precision VAE fix was used utilized. See, e.g., https://huggingface.co/madebyollin/sdxl-vae-fp16-fix. The images 1210, 1220, 1230 were generated by SDXL 1.0 in response to the text prompt “a photorealistic image of a person” using the following parameters: Seed: 12345, Guidance Scale: 5, Iterations: 50. To collect the images 1210, 1220, 1230, a “callback” feature was utilized which allows the latent values to be used (and also sent through the VAE decoder and saved to a local variable). FIG. 12A shows the image 1210 created by the diffusion model after N−2 iterations, FIG. 12B shows the image 1220 created by the diffusion model after N−1 iterations, FIG. 12C shows the image 1230 created by the diffusion model after N iterations.

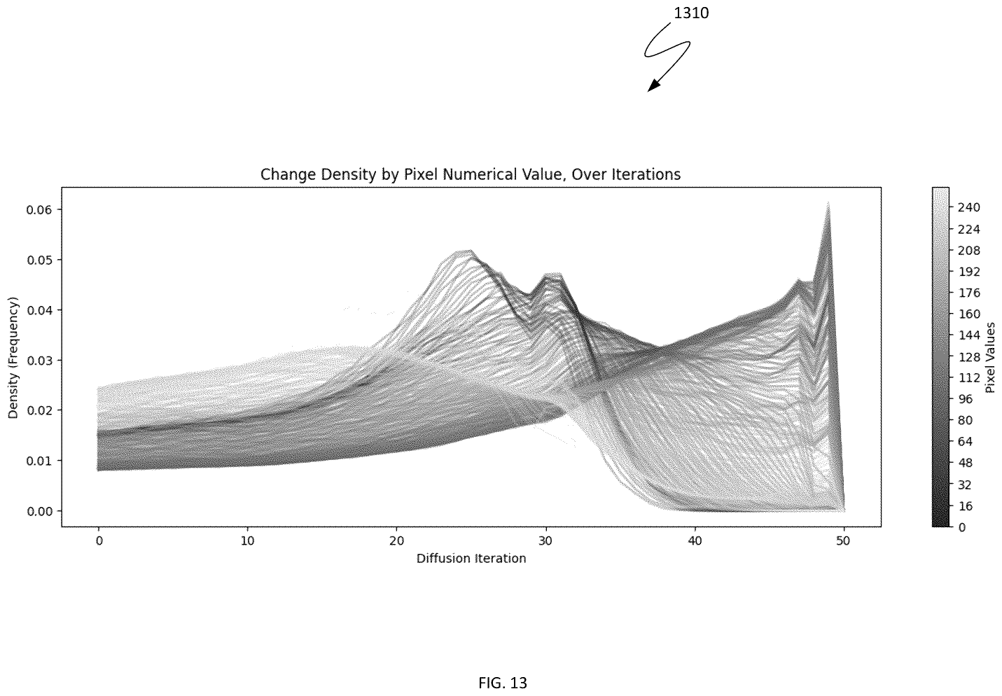

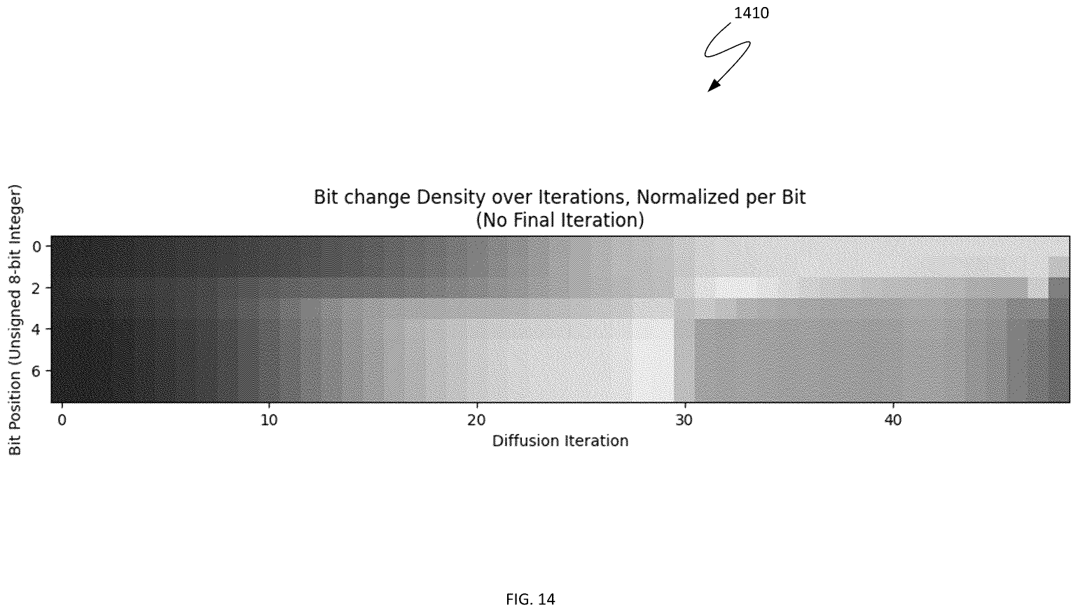

Referring now to FIG. 13, a graph 1310 is provided of change density by pixel numerical value as a function of the number of iterations of the diffusion process yielding the images of FIGS. 12-12C. Indeed, evaluation of overall changes, including total pixel value changes per iteration and count of pixel changes per iteration, leads to the observation that a large change in pixel values occurs in connection with the final iteration of the diffusion process and that relatively few pixel value changes occur during numerous other iterations. This is corroborated by FIG. 14, which is a graph 1410 illustrating bit change density as a function of the number of diffusion iterations, normalized per bit. FIGS. 13 and 14 provide clear evidence of a sparsity in pixel value and bit position changes over iterations, suggesting that the standard diffusion process is inefficient.

In accordance with the disclosure, the inefficiencies in conventional diffusion processes for image generation can be addressed by the parallel diffusion process described herein. In one approach to parallel diffusion the pixel range (0 to 255) may be divided into different floating-point values, thus allowing different ranges of values to be separately denoised. Alternatively, each bit may be represented by a floating-point value and denoised at the bit level. In either case the non-linearities (including any decision function at the final layer to reconstruct the final image) would mean that this proposal is distinguishable from simply increasing the precision of the diffusion (e.g., the disclosed parallel diffusion techniques are not the same as changing from 16-bit float to 32-bit float precision). The disclosed approach to parallel diffusion enables additional compute resources to be used to parallelize the denoising diffusion process, which is currently inherently sequential in nature.

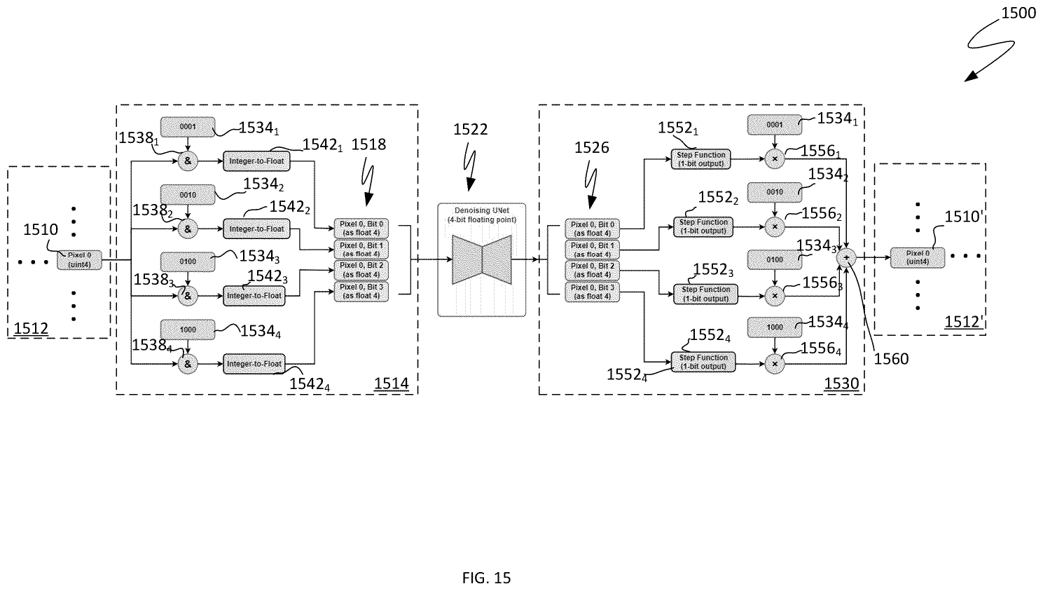

Attention is now directed to FIG. 15, which illustrates an exemplary parallel diffusion process 1500 for image generation in accordance with the disclosure. As is described below, each pixel 1510 of an input image 1512 is serially provided to a bit-level parallelization arrangement 1514 designed to transform the bits of each pixel 1510 into a parallel floating-point representation 1518. The parallel-floating-point representation 1518 of each pixel 1510 is provided to a machine-trained denoising artificial neural network 1522 (e.g., a UNet), which generates a separate output floating-point representation 1526 corresponding to each image pixel 1510. A process for training of the artificial network 1522 to perform the disclosed denoising operations is described below. Each output floating-point representation 1526 is provided to a bit-level de-parallelization arrangement 1530 configured to generate a reconstruction 1510′ of a corresponding one of the input image pixels 1510.

Although the embodiment of FIG. 15 deliberately uses 4-bit data types for purposes of clarity, the number of bits in the input image pixels 1510 and in the denoising operation may vary and need not match. Note also that the input pixel 1510 may be in a latent representation (e.g., VAE encoded)

Referring again to FIG. 15, a set of bit masks 1534 are applied in parallel to each input image pixel 1510 through a set of bit masking operations 1538. The binary results of each bit masking operation 1538 is then converted 1542 to the floating-point representation 1518 (e.g., binary 0 to float −1 and binary 1 to float +1). Upon completion of the binary-to-float conversion 1542 for a given pixel 1510, each bit of the pixel will be represented by 4 bits in the corresponding floating-point representation 1518. Consequently, the size of the input data provided to the artificial neural network 1522 has been increased by a factor of 4 relative to the original input pixel data 1510.

Within the bit-level de-parallelization arrangement 1530, positive values within each output floating-point representation 1526 are converted through conversion operations 1552 back to binary (e.g., by using a step function where negative values convert to zero and positive to 1). The results of each conversion operation 1552 are multiplied 1556 in fixed point by one of the bit masks 1534 and the results of the multiplications 1556 are added 1560. thereby producing a reconstruction 1510′ of the original input pixel 1510. Again, although 4-bit precision was shown in FIG. 15 for illustration purposes, the number of bits in the input pixels 1510 and output pixel reconstructions 1510′ may change and need not match, and may be in latent representations (e.g., VAE encoded).

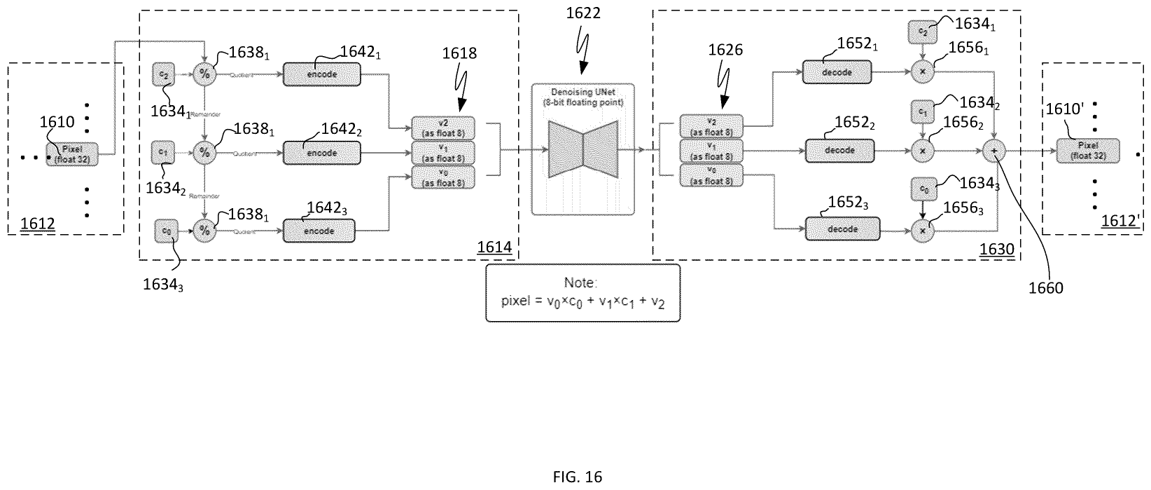

Turning now to FIG. 16, an illustration is provided of another exemplary parallel diffusion process 1600 for image generation in accordance with the disclosure. In the embodiment of FIG. 16 each 32-bit pixel 1610 of an input image 1612 is provided to a parallelization arrangement 1614 designed to transform the bits of each pixel 1610 into a parallel floating-point representation 1618. Specifically, each 32-bit image pixel 1610 (or latent value included within a latent representation of the image 1612) is factored into multiples of a constant cₖ(cₖ+1>cₖ). As shown, the input pixel 1610 is divided 1638₁ by a constant 1634₁ (c₂) with the quotient being provided to the encoder 1642₁ and the remainder undergoing division 1638 by the constant 1634₁ (c₁). The result of each division operation 1638 is then encoded 1642 to a floating-point representation (and may undergo further encoding such as spatial encoding). It may be appreciated that in the parallelization arrangement of FIG. 16 ranges of values, rather than single bit values, are converted to floating-point representations.

In the embodiment of FIG. 16 the interval between the constants cₖ(cₖ+1>cₖ) need not be uniform, and the smallest constant (c₀) may be omitted to prevent rounding. After conversion to a floating-point representation 1618, each 32-bit input pixel 1610 is now represented by 24 bits, thus decreasing the size of the input data by a factor of ¾. The overall computational burden is closer to a reduction in precision from float32 to effectively 24-bits of floats, but the inherent bit-level nonlinearity can have advantages.

The parallel-floating-point representation 1618 of each pixel 1610 is provided to a machine-trained denoising artificial neural network 1622 (e.g., a UNet), which generates a separate output floating-point representation 1626 corresponding to each image pixel 1610. A process for training of the artificial network 1622 to perform the disclosed denoising operations is described below. Each output floating-point representation 1626 is provided to a de-parallelization arrangement 1630 configured to generate a reconstruction 1610′ of a corresponding one of the input image pixels 1610.

Specifically, within the de-parallelization arrangement 1630 each floating-point representation 1626 is decoded 1652 and the decoding results multiplied 1656 by one of the constants 1634. As current state-of-the-art diffusion often denoises larger values in early iterations (coarse detail) and smaller values (fine detail) in later iterations, this factorization allows both the coarse and fine detail to be denoised simultaneously. The results of the multiplications 1656 are then added 1660 to generate the pixel reconstruction 1610′.

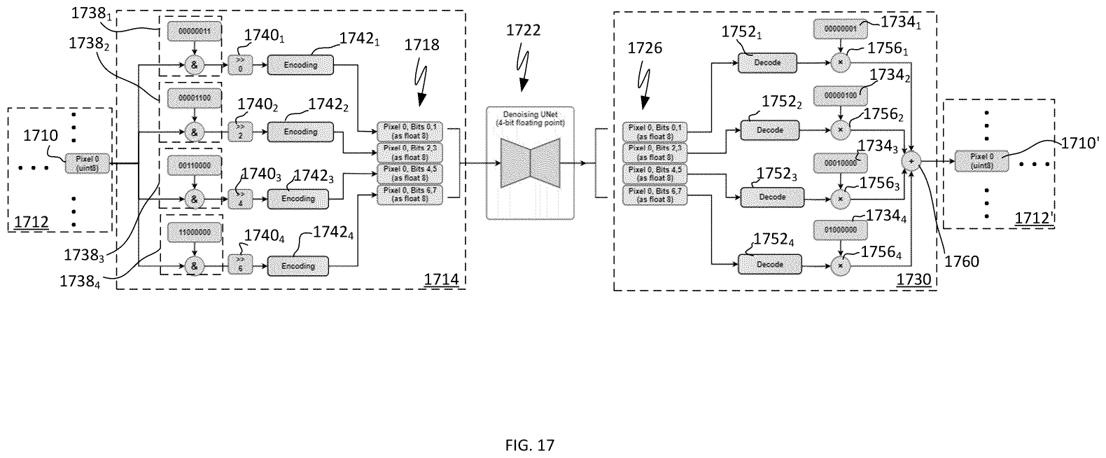

FIG. 17 illustrates another variation of an exemplary parallel diffusion process 1700 for image generation in accordance with the disclosure. The embodiment of FIG. 17 utilizes encoders but also works at the bit-level for realistic precisions (FP8+). By using 1 FP8 per 2-bits of each input pixel (uint8) 1710 and comparing against a standard FP32 (single-precision model), we have 4 FP8 for a total of 32-bits. In this way, minimal additional memory is added, and it serves as a way to both reduce precision but still obtain the parallel performance gains.

As is described below, each pixel 1710 of an input image 1712 is serially provided to a bit-level parallelization arrangement 1714 designed to transform the bits of each pixel 1710 into a parallel floating-point representation 1718. The parallel-floating-point representation 1718 of each pixel 1710 is provided to a machine-trained denoising artificial neural network 1722 (e.g., a UNet), which generates a separate output floating-point representation 1726 corresponding to each image pixel 1710. Each output floating-point representation 1726 is provided to a bit-level de-parallelization arrangement 1730 configured to generate a reconstruction 1710′ of a corresponding one of the input image pixels 1710.

The bit-level parallelization arrangement 1714 advantageously preserves the same memory space (32-bits) per pixel as a standard FP32 representation would require. In this embodiment four sets of adjacent bit pairs forming the floating-point representation 1726 are extracted from each input image pixel 1710 through a binary mask operation 1738 followed by a bit shift operation 1740. The subsequent encoding 1742 of the results of the bit shift operations 1740 can include various combinations of additional spatial and/or embedding encodings.

After denoising by the artificial neural network 1722, the resulting bit pairs in each output floating-point representation 1726 are decoded 1752 and multiplied 1556 by a set of values 1734, i.e., 1, 4, 6, and 8, then added 1760 to produce a reconstruction 1710′ of the original uint8 representation of the pixel 1710. Although the decoders 1752 in the embodiment of FIG. 17 operate to decode to two bits, the number of bits jointly encoded per pixel may vary producing either more, less or the same overall memory representation. In addition, in embodiments in which each pixel 1710 is in a latent representation (e.g., VAE encoded), a conversion would be performed from the VAE precision back to the fixed-point representation utilized in the embodiment of FIG. 17.

It may be appreciated that representing each input image bit as a floating-point value inherently applies a non-linearity prior to recombining such bits at the output of the denoising U-Net or other artificial neural network. It may thus be seen that the bit-level diffusion processes described herein are not the same as simply increasing floating-point precision. Although this may result in additional computational cost, which is to be expected when a serial operation is parallelized, this was previously not an available option when utilizing conventional diffusion processes.

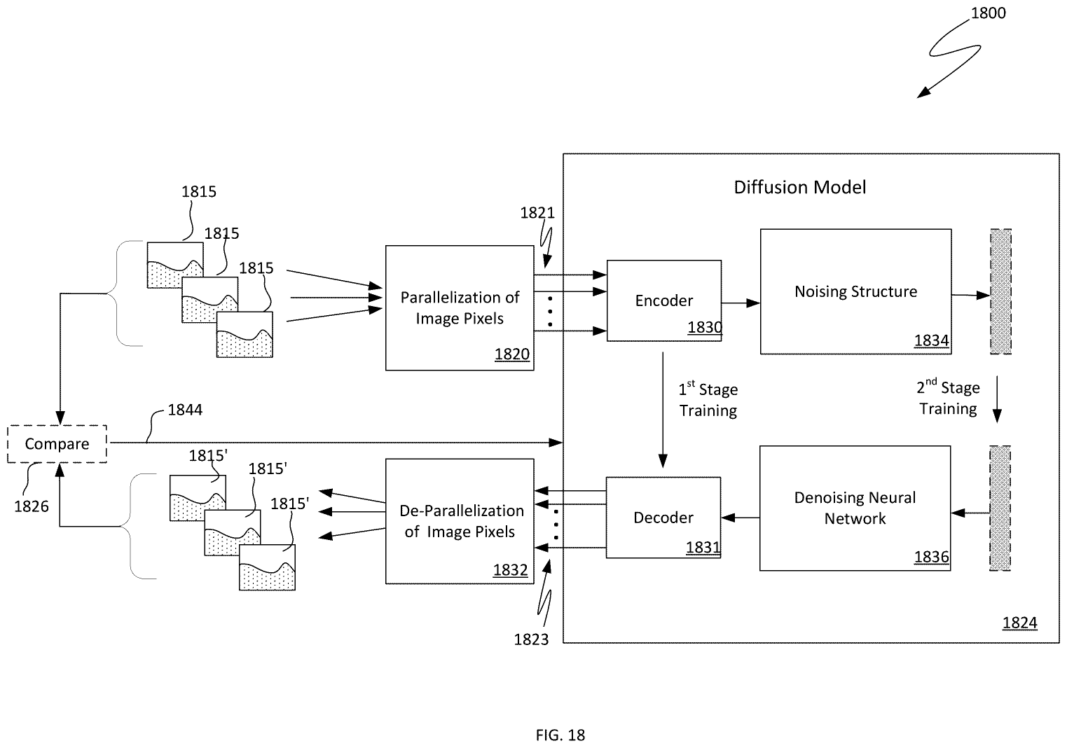

Reference is now made to FIG. 18, which illustrates a process 1800 for conditionally training a diffusion model for use in parallel diffusion in accordance with the disclosure. In one embodiment the encoder 1830 and the decoder 1831 of the diffusion model, which may be a generative model such as a version of Stable Diffusion, are initially trained using solely the training image frames 1815 to learn a latent space associated with the training image frames 1815. Specifically, the training image frames 1815 are provided to a parallelization arrangement 1820 configured to transform the bits of each pixel of each training image 1815 into a parallel floating-point representation 1821. The encoder 1830 maps the input parallel floating-point representations 1821 of the pixels of the image frames 1815 to a latent space and the decoder 1831 generates corresponding output parallel floating-point representations 1823 from samples in that latent space. A de-parallelization arrangement 1832 generates reconstructed images 1815′ from the output parallel floating-point representations 1823. The encoder 1830 and decoder 1831 may be adjusted 1844 during training to minimize differences identified by comparing 1826 the reconstructed imagery 1815′ generated by the decoder 1831 and the de-parallelization arrangement 1832 with the training image frames 1815.

After 1^{st} stage training of the encoder 1830 and decoder 1831, the combined diffusion model 1824 (encoder 1830, decoder 1831, and diffusion stages 1834, 1836) in combination with the parallelization arrangement 1820 and the de-parallelization arrangement 1832 may then be trained during a 2^{nd} stage using the image frames 1815 acquired for training. During this training phase the model 1824 is guided 1844 to generate reconstructed images 1815′ through the parallel diffusion process that resemble the image frames 1815.

In some embodiments the diffusion model 1824 may have been previously trained using image other than the training image frames 1815. In such cases it may be sufficient to perform only the 1^{st} stage training pursuant to which the encoder 1830 and decoder 1831 are trained to learn the latent space associated with the training image frames.

That is, it may be unnecessary to perform the 2^{nd} stage training involving the entire diffusion model 1824 (i.e., the encoder 1830, decoder 1831, noising structure 1834, denoising network 1836) in combination with the parallelization arrangement 1820 and the de-parallelization arrangement 1832.

Where methods described above indicate certain events occurring in certain order, the ordering of certain events may be modified. Additionally, certain of the events may be performed concurrently in a parallel process when possible, as well as performed sequentially as described above. Accordingly, the specification is intended to embrace all such modifications and variations of the disclosed embodiments that fall within the spirit and scope of the appended claims.

The foregoing description, for purposes of explanation, used specific nomenclature to provide a thorough understanding of the claimed systems and methods. However, it will be apparent to one skilled in the art that specific details are not required to practice the systems and methods described herein. Thus, the foregoing descriptions of specific embodiments of the described systems and methods are presented for purposes of illustration and description. They are not intended to be exhaustive or to limit the claims to the precise forms disclosed; obviously, many modifications and variations are possible in view of the above teachings. The embodiments were chosen and described to best explain the principles of the described systems and methods and their practical applications, they thereby enable others skilled in the art to best utilize the described systems and methods and various embodiments with various modifications as are suited to the particular use contemplated. It is intended that the following claims and their equivalents define the scope of the systems and methods described herein.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an.” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising.” “including,” “carrying.” “having,” “containing,” “involving.” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A computer-implemented method, comprising:
receiving an input image including a plurality of pixels where each of the plurality of pixels is represented by multiple bits;
transforming the multiple bits representing each of the plurality of pixels of the input image into a set of floating-point values;
providing the set of floating-point values for each of the plurality of pixels of the input image to a denoising model of a machine-trained diffusion model;
generating, by the denoising model, successive sets of floating-point values; and
reconstructing the plurality of pixels of the input image from the successive sets of floating-point values.

2. The computer-implemented method of claim 1 wherein the transforming includes, for each pixel of the plurality of pixels of the input image:
applying multiple bit masks arranged in parallel to the multiple bits of the pixel wherein different ones of the bits masks are applied to different ones of the multiple bits of the pixel;
converting integer outputs resulting from the applying of the multiple bit masks into the set of floating-point values for the pixel.

3. The computer-implemented method of claim 1 wherein the reconstructing further includes converting the successive sets of floating-point values generated by the denoising model into successive sets of binary values wherein each of the successive sets of floating-point values corresponds to one of the plurality of pixels of the input image.

4. The computer-implemented method of claim 3 wherein the reconstructing further includes, for each successive set of binary values:
multiplying each binary value of each successive set of binary values by a different one of multiple bit masks,
adding results of the multiplying in order to generate multiple reconstructed bits of one pixel of the plurality of pixels of the input image.

5. A computing system, comprising:
one or more processors; and
one or more non-transitory, computer-readable media storing a machine-implemented diffusion model including a denoising model and instructions that, when executed by the one or more processors, cause the one or more processors to:
receive an input image including a plurality of pixels where each of the plurality of pixels is represented by multiple bits;
transform the multiple bits representing each of the plurality of pixels of the input image into a set of floating-point values;
provide the set of floating-point values for each of the plurality of pixels of the input image to the denoising model;
generate, by the denoising model, successive sets of floating-point values; and
reconstruct the plurality of pixels of the input image from the successive sets of floating-point values.

6. The computing system of claim 5 wherein the instructions to transform further include instructions which, for each pixel of the plurality of pixels of the input image, cause the one or more processors to:
apply multiple bit masks arranged in parallel to the multiple bits of the pixel wherein different ones of the bits masks are applied to different ones of the multiple bits of the pixel to yield integer outputs,
convert the integer outputs into the set of floating-point values for the pixel.

7. The computer-implemented system of claim 5 wherein the instructions to reconstruct further include instructions to cause the one or more processors to convert successive sets of floating-point values generated by the denoising model into successive sets of binary values wherein each of the successive set of floating-point values corresponds to one of the plurality of pixels of the input image.

8. The computer-implemented method of claim 7 wherein the instructions to reconstruct further include instructions to cause, for each successive set of binary values, the one or more processors to:
multiply each binary value of each successive set of binary values by a different one of the multiple bit masks,
add results of the multiplying in order to generate multiple reconstructed bits of one pixel of the plurality of pixels of one of the input image.

9. The method of claim 8 further comprising training or fine tuning with training imagery to optimize performance.

10. The method of claim 8 further comprising re-weighting different connections of the denoising model per parallel branch.

11. The method of claim 8 further comprising employing different masking and quantization strategies.

12. The method of claim 8 further comprising transforming input data to another domain, including to the frequency domain via a Fourier transform variant, to form an output; and inverse transforming the output.
